(19) United States
(12) Patent Application Publication
(10) Pub. No.: US 2026/0228240 A1
(43) Pub. Date: Aug. 6, 2026

(54) DATABASE MANAGEMENT METHOD AND INFORMATION PROCESSING SYSTEM

(71) Applicant: Kioxia Corporation, Tokyo (JP)

(72) Inventors: Shinichi KANNO, Tokyo (JP); Toru WATABE, Yokohama (JP); Takahiro KURITA, Sagamihara (JP)

(73) Assignee: Kioxia Corporation, Tokyo (JP)

(21) Appl. No.: 19/324,317

(22) Filed: Sep. 10, 2025

(30) Foreign Application Priority Data
Jan. 31, 2025 (JP) 2025-015073

(51) Int. Cl. G06F 16/28

(52) U.S. Cl. CPC G06F 16/285

(57) ABSTRACT

According to one embodiment, a database management method manages a plurality of clusters each having a representative vector. When registering a first D-dimensional vector in a vector database, the method identifies a cluster that has a representative vector closest to the first D-dimensional vector among the plurality of clusters, and calculates D differences obtained by subtracting D elements contained in the representative vector of the identified cluster from D elements contained in the first D-dimensional vector, respectively. The method stores an identifier of the identified cluster and the D differences in the vector database, as position information of the first D-dimensional vector.

### CROSS-REFERENCE TO RELATED APPLICATIONS

This application is based upon and claims the benefit of priority from Japanese Patent Application No. 2025-015073, filed Jan. 31, 2025, the entire contents of which are incorporated herein by reference.

### FIELD

Embodiments described herein relate generally to a database management method and information processing system for managing a vector database.

### BACKGROUND

Vector databases are used in various fields such as machine learning and data mining. In a vector database, individual data are stored as high-dimensional vectors containing a large number of feature values respectively corresponding to a large number of attributes.

When attempting to construct a large-scale vector database capable of storing a large number of high-dimensional vectors exceeding the billion scale, the amount of data in a vector set increases dramatically, thereby requiring a storage area of an extremely large capacity.

As methods for reducing the amount of data in vector sets, inverted file with production quantization (IVFPQ) and inverted file with scalar quantization (IVFSQ) are known.

However, in IVFPQ and IVFQS, the variation in the distribution of vectors within the vector set stored in the vector database can cause large quantization errors, which may lead to a decrease in search accuracy.

Therefore, in vector databases, there is a need for a new technology that can reduce the amount of data in the vector set stored in the vector database while suppressing the decrease in search accuracy.

### BRIEF DESCRIPTION OF THE DRAWINGS

FIG. 1 is a block diagram illustrating a configuration example of an information processing system according to a first embodiment.

FIG. 2 is a diagram illustrating examples of a plurality of clusters managed in the information processing system according to the first embodiment.

FIG. 3 is a diagram illustrating differences between vectors within a cluster and a representative vector of the cluster.

FIG. 4 is a diagram illustrating examples of the number of bits of data representing each element of an original vector and the number of bits of data representing each element of a difference DIFF.

FIG. 5 is a diagram illustrating examples of a data format of floating-point number representing each element of the original vector and a data format of floating-point number representing each element of the difference DIFF.

FIG. 6 is a diagram illustrating examples of the data format of floating-point number representing each element of the original vector and a data format of fixed-point number representing each element of the difference DIFF.

FIG. 7 is a diagram illustrating an example of cluster information managed in the information processing system according to the first embodiment.

FIG. 8 is a diagram illustrating an example of vector position information managed in the information processing system according to the first embodiment.

FIG. 9 is a diagram illustrating an example of cluster-to-cluster vector movement processing executed in the information processing system according to the first embodiment.

FIG. 10 is a diagram illustrating an example of a process for calculating a difference between a vector and a representative vector of a destination cluster to which the vector is moved.

FIG. 11 is a diagram illustrating an example of remote vector addition processing executed in the information processing system according to the first embodiment.

FIG. 12 is a diagram illustrating an example of vectors subject to distance calculation.

FIG. 13 is a diagram illustrating an example of distance calculation processing that calculates a distance between a vector subject to distance calculation and a query vector.

FIG. 14 is a flowchart illustrating an example of a procedure for cluster generation processing executed in the information processing system according to the first embodiment.

FIG. 15 is a flowchart illustrating an example of a procedure for vector registration processing executed in the information processing system according to the first embodiment.

FIG. 16 is a flowchart illustrating an example of a procedure for cluster addition and vector movement processing executed in the information processing system according to the first embodiment.

FIG. 17 is a flowchart illustrating an example of a procedure for vector movement processing executed in the information processing system according to the first embodiment.

FIG. 18 is a flowchart illustrating an example of a procedure for remote vector registration processing executed in the information processing system according to the first embodiment.

FIG. 19 is a flowchart illustrating an example of a procedure for distance calculation processing executed in the information processing system according to the first embodiment.

FIG. 20 is a block diagram illustrating a configuration example of an information processing system according to a second embodiment.

FIG. 21 is a diagram illustrating examples of a plurality of clusters managed for each subvector space in the information processing system according to the second embodiment.

FIG. 22 is a diagram illustrating a difference between a subvector and a representative vector of a cluster of a subvector space.

FIG. 23 is a diagram illustrating examples of the number of bits of data representing each element of a subvector and the number of bits of data representing each element of a difference DIFF.

FIG. 24 is a diagram illustrating examples of a data format of floating-point number representing each element of a subvector and a data format of floating-point number representing each element of the difference DIFF.

FIG. 25 is a diagram illustrating examples of a data format of floating-point number representing each element of a subvector and a data format of fixed-point number representing each element of the difference DIFF.

FIG. 26 is a diagram illustrating an example of cluster information managed in the information processing system according to the second embodiment.

FIG. 27 is a diagram illustrating an example of vector position information managed in the information processing system according to the second embodiment.

FIG. 28 is a diagram illustrating an example of a vector added in the information processing system according to the second embodiment.

FIG. 29 is a diagram illustrating an example of cluster-to-cluster subvector movement processing executed in the information processing system according to the second embodiment.

FIG. 30 is a diagram illustrating an example of a process for calculating a difference between a subvector and a representative vector of a destination cluster to which the subvector is moved.

FIG. 31 is a diagram illustrating an example of a remote vector added in the information processing system according to the second embodiment.

FIG. 32 is a diagram illustrating an example of remote vector registration processing executed in the information processing system according to the second embodiment.

FIG. 33 is a diagram illustrating an example of vectors subject to distance calculation.

FIG. 34 is a diagram illustrating an example of distance calculation processing that calculates a distance between each subvector of the vectors subject to distance calculation and a query vector.

FIG. 35 is a flowchart illustrating an example of a procedure for cluster generation processing executed in the information processing system according to the second embodiment.

FIG. 36 is a flowchart illustrating an example of a procedure for vector registration processing executed in the information processing system according to the second embodiment.

FIG. 37 is a flowchart illustrating an example of a procedure for cluster addition and subvector movement processing executed in the information processing system according to the second embodiment.

FIG. 38 is a flowchart illustrating an example of a procedure for subvector movement processing executed in the information processing system according to the second embodiment.

FIG. 39 is a flowchart illustrating an example of a procedure for remote vector registration processing executed in the information processing system according to the second embodiment.

FIG. 40 is a flowchart illustrating an example of a procedure for distance calculation processing executed in the information processing system according to the second embodiment.

### DETAILED DESCRIPTION

Various embodiments will be described hereinafter with reference to the accompanying drawings.

One or more embodiments provides a database management method and an information processing system that can reduce the amount of data of vectors stored in a vector database while suppressing a decrease in search accuracy.

In general, according to one embodiment, a database management method for managing a vector database manages a plurality of clusters, each of which has a representative vector that indicates a representative point within a D-dimensional vector space and has D dimensions. D is an integer of two or more. When registering a first D-dimensional vector in the vector database, the database management method identifies a cluster among the plurality of clusters that has a representative vector closest to the first D-dimensional vector as a cluster to which the first D-dimensional vector should belong. The database management method calculates D differences obtained by subtracting D elements contained in the representative vector of the identified cluster from D elements contained in the first D-dimensional vector, respectively. The database management method stores an identifier of the identified cluster and the D differences in the vector database, as position information indicating a position of the first D-dimensional vector within the D-dimensional vector space in the vector database.

### First Embodiment

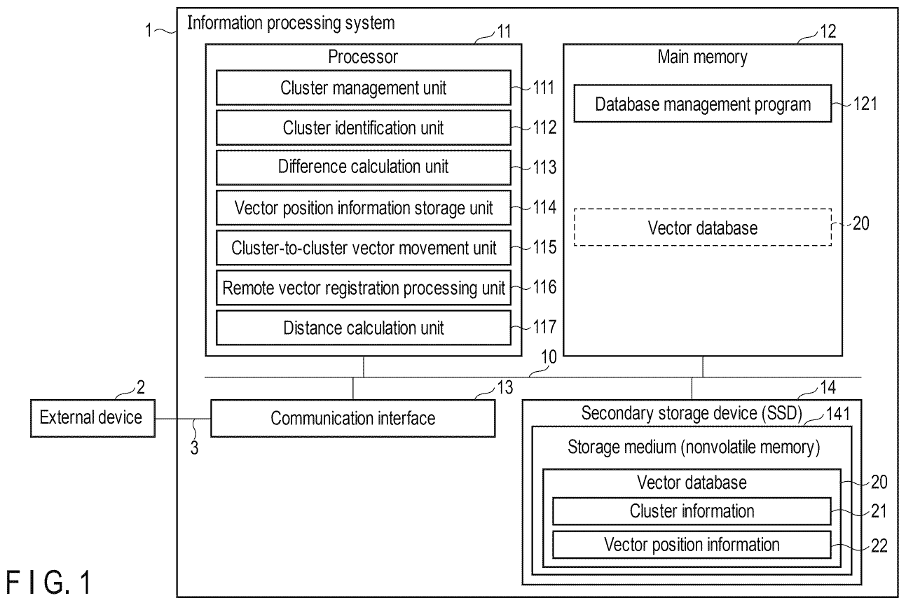

FIG. 1 is a block diagram illustrating a configuration example of an information processing system 1 according to a first embodiment. The information processing system 1 is a computer system configured to manage a vector database 20.

The vector database 20 is a database for storing and managing a plurality of vectors. Each of the plurality of vectors is an uncompressed vector, i.e., a full-precision vector.

Each of the plurality of vectors includes a plurality of feature values corresponding to a plurality of dimensions. If the number of dimensions of each vector is D, then each vector (D-dimensional vector) corresponds to a point (data point) in a D-dimensional vector space. Each of the D elements included in the D-dimensional vector represents a feature value (real number) for each of the D attributes. Each vector includes a high-dimensional vector whose number of dimensions D is several hundred or several thousand. The number of dimensions D is an integer of at least two, and the number of dimensions D of the high-dimensional vector is, for example, 256, 1024, or 2048. Hereinafter, the vector space is also referred to as data space.

The information processing system 1 executes processing of registering each vector in the vector database 20 based on a request from an external device 2.

The information processing system 1 also receives a query from the external device 2. The query vector based on the query represents target data (target vector) to be searched for from the vector database 20. The query vector has the same number of dimensions D as each vector in the vector database 20. That is, the query vector also contains D feature values corresponding to each of the D dimensions, similar to each vector in the vector database 20. Hereinafter, the query vector is also referred to simply as a query.

The information processing system 1 executes approximate nearest neighbor search on the vector database 20 based on the received query. Approximate nearest neighbor search is a search method that quickly searches for vectors (approximate nearest neighbor vectors) that are sufficiently close to the query in terms of a certain distance metric.

In the first embodiment, for example, a Euclidean distance is used as a distance metric for representing a distance between vectors. In this case, essentially, several candidate vectors are selected from all vectors in the vector database. Then, for each of the selected candidate vectors, the Euclidean distance to the query (query vector) is calculated, and a search is executed to find the vector among the candidate vectors with the shortest Euclidean distance to the query as a solution to the nearest neighbor search (approximate nearest neighbor vector of the query).

Note that the distance metric is not limited to the Euclidean distance and may be any other distance that can represent the distance between vectors.

Next, a configuration of the information processing system 1 is described. The information processing system 1 includes a processor 11, a main memory 12, a communication interface 13, and a secondary storage device 14. The processor 11, the main memory 12, the communication interface 13, and the secondary storage device 14 are interconnected via a bus 10.

The processor 11 is, for example, a central processing unit (CPU). The processor 11 is capable of accessing the main memory 12 and the secondary storage device 14. The processor 11 executes various processing, including generating cluster information 21 and vector position information 22, storing the cluster information 21 and the vector position information 22 in the vector database 20 of the secondary storage device 14, and performing searches, by executing a computer program (here, database management program 121) stored in the main memory 12. The cluster information 21 and the vector position information 22 are used as index information. The index information is a data structure used to search for the target vector (approximate nearest neighbor vector of the query) from the vector database 20.

The main memory 12 is a memory device with low access latency, such as dynamic random access memory (DRAM). A storage area of the main memory 12 is used to store programs to be executed by the processor 11 and as a working area for the processor 11. Note that the vector database 20 (i.e., the cluster information 21 and the vector position information 22) may be stored in the main memory 12.

The communication interface 13 is a communication device. The communication interface 13 executes communication with the external device 2 via a communication path 3, such as a network or bus.

The secondary storage device 14 is a storage device that has a larger capacity than the main memory 12 and a slower access speed than the main memory 12. The secondary storage device 14 may be implemented by a hard disk drive (HDD) or a solid-state drive (SSD). Hereinafter, a case where the secondary storage device 14 is implemented by an SSD is assumed.

An SSD is a memory system comprising a nonvolatile memory and a controller configured to control the nonvolatile memory.

The nonvolatile memory includes a plurality of blocks (also referred to as “memory blocks,” “physical blocks,” or “flash blocks”), each of which is a unit for data erasure operations. Each of the plurality of blocks includes a plurality of pages, each of which is a unit for data write operations and data read operations. The nonvolatile memory is, for example, a NAND flash memory. The NAND flash memory is, for example, a flash memory with a three-dimensional structure. The nonvolatile memory is not limited to the NAND flash memory, and other data storage devices such as an MRAM may be used.

The controller is a memory controller having a circuit and is implemented, for example, as an LSI such as a System-on-a-Chip (SoC).

Next, a functional configuration of the processor 11 is described.

The processor 11 functions as a cluster management unit 111, a cluster identification unit 112, a difference calculation unit 113, a vector position information storage unit 114, a cluster-to-cluster vector movement unit 115, a remote vector registration processing unit 116, and a distance calculation unit 117 by executing the database management program 121. Note that each of the cluster management unit 111, the cluster identification unit 112, the difference calculation unit 113, the vector position information storage unit 114, the cluster-to-cluster vector movement unit 115, the remote vector registration processing unit 116, and the distance calculation unit 117 may be implemented by dedicated hardware (circuits) within the information processing system 1.

The cluster management unit 111 generates and manages a plurality of clusters. Each of the plurality of clusters has a representative vector that indicates a representative point in the D-dimensional vector space and has D dimensions.

Each of the plurality of clusters includes a group of vectors that are close to its representative vector (representative point). The relationship between a cluster and the group of vectors belonging to that cluster is determined as follows.

For example, a case is assumed in which a cluster X having a representative vector x, a cluster Y having a representative vector y, and a cluster Z having a representative vector z are managed.

In this case, each vector close to the representative vector x is managed as belonging to the cluster X, each vector close to the representative vector y is managed as belonging to the cluster Y, and each vector close to the representative vector z is managed as belonging to the cluster Z.

The distance from each vector belonging to a certain cluster to the representative vector of that cluster is shorter than the distance from each of these vectors to the representative vectors of each of the other clusters. That is, each vector belongs to the cluster whose representative vector is closest to it.

The representative vector of a certain cluster may, for example, be a vector indicating the centroid of that cluster. Alternatively, any one of the vectors belonging to a certain cluster may be used as the representative vector of that cluster. This arbitrary vector may be the vector closest to the centroid of the cluster among the vectors belonging to the cluster, or may be a vector unrelated to the distance from the centroid of the cluster. Note that the centroid of a certain cluster is a vector that indicates the center of a plurality of data points respectively corresponding to a plurality of vectors belonging to this cluster, and is determined by calculating an average value of each element of these vectors.

When registering a certain vector (first D-dimensional vector) in the vector database 20, the cluster identification unit 112 identifies a cluster that has a representative vector closest to the first D-dimensional vector among the plurality of clusters, as the cluster to which the first D-dimensional vector should belong.

The difference calculation unit 113 calculates D differences obtained by subtracting the D elements contained in the representative vector of the identified cluster from the D elements contained in the first D-dimensional vector, respectively. These D differences are the D elements contained in the vector difference between the first D-dimensional vector and the representative vector of the identified cluster. The vector difference between the first D-dimensional vector and the representative vector of the identified cluster, i.e., the D differences obtained by subtracting the D elements contained in the representative vector of the identified cluster respectively from the D elements contained in the first D-dimensional vector, is also referred to as a difference DIFF or a difference vector.

The vector position information storage unit 114 stores in the vector database 20 an identifier of the identified cluster and the calculated D differences (i.e., the difference DIFF between the first D-dimensional vector and the representative vector of the identified cluster) as position information (the vector position information 22) indicating the position of the first D-dimensional vector in the D-dimensional vector space.

The first D-dimensional vector is a vector that is close to the representative vector of the identified cluster. Therefore, an absolute value of each of the D differences obtained by subtracting the D elements contained in the representative vector of the specified cluster from the D elements contained in the first D-dimensional vector, respectively, is much smaller than an absolute value of each element of the first D-dimensional vector. That is, data representing each of the D differences can be realized using a small number of bits that can express only a narrow range within the D-dimensional vector space. Therefore, the number of bits of data representing each of the D differences can be reduced to the number of bits fewer than the number of bits of data representing each element of an original vector (here, the first D-dimensional vector, also referred to as a full-precision vector).

Therefore, compared to a case where each original vector itself is stored uncompressed in the vector database 20 as the vector position information 22, the amount of data (size of the vector position information 22) of the vector set stored in the vector database 20 can be reduced.

In this manner, the configuration of storing the identifier of the identified cluster and the calculated D differences (i.e., the difference DIFF between the first D-dimensional vector and the representative vector of the identified cluster) in the vector database 20 as position information indicating the position of the first D-dimensional vector is equivalent to performing vector quantization of the first D-dimensional vector using the identified cluster, and storing data representing a quantization error (the difference DIFF between the first D-dimensional vector and the representative vector of the identified cluster) as position information indicating the position of the first D-dimensional vector.

The D elements (D real numbers) of the first D-dimensional vector can be restored by adding the representative vector of the identified cluster to the difference DIFF corresponding to the first D-dimensional vector, as necessary.

Note that the distance (Euclidean distance) between certain two vectors can be calculated by performing processing such as restoring each of the two vectors, obtaining the sum of squares of D differences between D elements of one of the restored two vectors and D elements of the other vector, and then obtaining the square root of this sum of squares.

However, since the processing of restoring the vector simply involves adding the representative vector to the difference DIFF corresponding to the vector, in a case where the two differences DIFF respectively corresponding to the two vectors subject to distance calculation are calculated in advance, the Euclidean distance between these two vectors can be calculated by obtaining the sum of squares of D differences between the D elements contained in one of the two differences DIFF and the D elements contained in the other difference DIFF, and then obtaining the square root of this sum of squares. Therefore, the Euclidean distance between these two vectors can be calculated with fewer computational steps by omitting the processing of adding the representative vector.

For example, in a case of calculating the distance (Euclidean distance) between a query vector and each of the plurality of vectors belonging to a certain cluster, the Euclidean distance can be calculated by performing the following processing (1) and (2), without restoring the difference DIFF of each vector to the original vector.
(1) Calculate D differences (D differences corresponding to the query vector) obtained by subtracting the D elements contained in the representative vector of the cluster from the D elements contained in the query vector, respectively.
(2) Acquire, from the vector database 20, D differences (D differences corresponding to a first vector) obtained by subtracting the D elements contained in the representative vector of the cluster from the D elements contained in the first vector in the cluster, respectively, obtain the sum of squares of D differences between the D elements corresponding to the query vector and D elements corresponding to the first vector, and then obtain the square root of this sum of squares.

The square root of the obtained sum of squares becomes a value equal to the square root of the sum of squares of the D differences between the D elements contained in the query vector and the D elements contained in the first vector.

Also, for each of a second and subsequent vectors in the cluster, the Euclidean distance between each of the second and subsequent vectors and the query vector can be calculated by processing similar to that for the first vector. Note that the D differences corresponding to the query vector have already been calculated in the processing for the first vector; therefore, there is no need to calculate them again in the processing for each of the second and subsequent vectors. Furthermore, in a case of searching for the vector closest to the query vector from the vectors belonging to a certain cluster, it is sufficient to compare the distances to the query vector among the vectors belonging to that cluster. Therefore, for each vector belonging to that cluster, the sum of the squares of the D differences between the D differences corresponding to that vector and the D differences corresponding to the query vector can be calculated as the distance (squared distance) to the query vector, and the distances (squared distances) to the query vector may be compared among those vectors.

By performing the processing of (1) and (2) described above, the distance between the query vector and each of the plurality of vectors belonging to a certain cluster can be correctly calculated using the D differences obtained by subtracting the D elements of the representative vector of the cluster from the D elements of the query vector, respectively (the D differences corresponding to the query vector), and the D differences obtained by subtracting the D elements of the representative vector from the D elements of each vector, respectively (the D differences corresponding to each vector).

Therefore, without storing each D-dimensional vector itself as the vector position information 22 in the vector database 20, it is possible to achieve search accuracy equivalent to that obtained in a case where each D-dimensional vector itself is stored in the vector database 20 as the vector position information 22.

The cluster-to-cluster vector movement unit 115 executes processing to change a cluster to which a certain vector belongs from the cluster to which the vector currently belongs to a new cluster. Specifically, when a new cluster having a representative vector is generated, the cluster-to-cluster vector movement unit 115 identifies a vector (a second D-dimensional vector) whose distance to the representative vector of the new cluster is shorter than its distance to a representative vector of a first cluster from a set of D-dimensional vectors belonging to the cluster (the first cluster) that is close to the representative vector of the new cluster. Then, the cluster-to-cluster vector movement unit 115 executes movement processing to move the second D-dimensional vector from the first cluster to the new cluster.

When executing the movement processing, the cluster-to-cluster vector movement unit 115 acquires, from the vector position information 22 in the vector database 20, D first differences obtained by subtracting the D elements contained in the representative vector of the first cluster from the D elements contained in the second-dimensional vector, respectively. The D first differences are differences DIFF between the second-dimensional vector and the representative vector of the first cluster, and are calculated in advance.

Next, the cluster-to-cluster vector movement unit 115 calculates D second differences obtained by subtracting the D elements contained in the representative vector of the new cluster from the D elements contained in the representative vector of the first cluster, respectively. Then, the cluster-to-cluster vector movement unit 115 calculates D third differences obtained by adding the D second differences respectively to the D first differences. The D third differences are the differences DIFF between the second D-dimensional vector and the representative vector of the new cluster, i.e., are obtained by subtracting the D elements contained in the representative vector of the new cluster from the D elements contained in the second D-dimensional vector, respectively, and indicate D differences. Therefore, the differences DIFF between the second D-dimensional vector and the representative vector of the new cluster can be calculated without restoring the differences DIFF corresponding to the second D-dimensional vector, i.e., the differences DIFF between the second D-dimensional vector and the representative vector of the first cluster, to the second D-dimensional vector (original vector).

The cluster-to-cluster vector movement unit 115 then stores an identifier of the new cluster and D third differences (the differences between the second-dimensional vectors and the representative vector of the new cluster) as information indicating positions of the second-dimensional vectors in the D-dimensional vector space in the vector database 20.

In a case where there are a plurality of vectors in the set of D-dimensional vectors belonging to the first cluster whose distance to the representative vector of the new cluster is shorter than the distance to the representative vector of the first cluster, movement processing is executed for all of these vectors. Once calculated, the D second differences can be commonly used in the movement processing for all of these vectors.

The remote vector registration processing unit 116 executes processing to reduce errors when registering a remote vector. The remote vector is a vector whose distance to all representative vectors of a plurality of generated clusters exceed a maximum value of difference that is expressible by data (second data) having a reduced number of bits. For any cluster of the plurality of generated clusters, a numerical value of each of the D differences obtained by subtracting the D elements of the representative vector of that cluster from the D elements of the remote vector, respectively, is greater than the maximum value of difference that can be expressed by the second data. Therefore, if the remote vector is registered in one of the plurality of generated clusters, it would become impossible to correctly represent each numerical value of the D differences obtained by subtracting the D elements of the representative vector of that one cluster from the D elements of the remote vector, respectively. As the result, the error in each of the D differences would increase.

Therefore, the remote vector registration processing unit 116 generates a new cluster having a representative vector that is close to the remote vector. The representative vector close to the remote vector is a representative vector that indicates an arbitrary position within a particular range from the position of the remote vector in the vector space. For example, a vector that indicates the same position as the position of the remote vector in the vector space may be used as the representative vector close to the remote vector.

Next, the remote vector registration processing unit 116 calculates D fourth differences obtained by subtracting the D elements contained in the representative vector of the new cluster from the D elements contained in the remote vector, respectively. Then, the remote vector registration processing unit 116 stores an identifier of the new cluster and the D fourth differences as information indicating a position of the new vector in the D-dimensional vector space (the vector position information 22) in the vector database 20. This reduces the error when registering remote vectors.

When a D-dimensional query vector is given, the distance calculation unit 117 calculates the distance (Euclidean distance) between a vector subject to distance calculation (a third D-dimensional vector) and the query vector. Specifically, the distance calculation unit 117 acquires, from the vector position information 22 in the vector database 20, D fifth differences obtained by subtracting D elements contained in a representative vector of a second cluster, to which the third D-dimensional vector belongs, from D elements contained in the third D-dimensional vector, respectively. The D fifth differences are the differences (DIFF) between the third D-dimensional vector and the representative vector of the second cluster to which the third D-dimensional vector belongs, and are calculated in dimensions. Next, the distance calculation unit 117 calculates D sixth differences obtained by subtracting D elements contained in the representative vector of the second cluster from D elements contained in the query vector, respectively. Then, the distance calculation unit 117 calculates the sum of squares (squared distance) of D seventh differences between the D fifth differences and the D sixth differences, or the square root of the sum of squares (Euclidean distance).

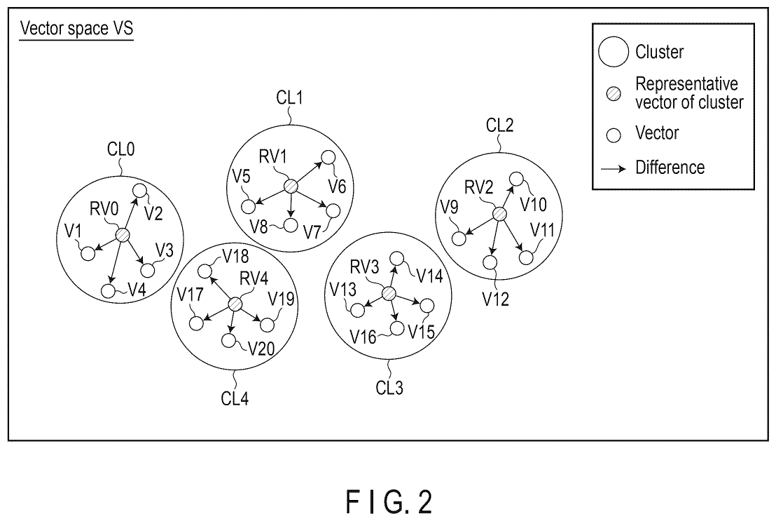

Next, a plurality of clusters generated in the D-dimensional vector space is described. FIG. 2 is a diagram illustrating an example of a plurality of clusters managed in the information processing system 1 according to the first embodiment.

In FIG. 2, the D-dimensional vector space is represented as vector space VS. In FIG. 2, a case where five clusters CL0 to CL4 are generated in the vector space VS is shown as an example.

The cluster CL0 has a representative vector RV0 that represents a certain representative point within the vector space VS. Four vectors V1 to V4 belong to the cluster CL0. Each of the vectors V1 to V4 is a D-dimensional vector that is close to the representative vector RV0 of cluster CL0. Arrows from the representative vector RV0 to each of the vectors V1 to V4 represent the differences (vector differences) between each of the vectors V1 to V4 and the representative vector RV0.

The cluster CL1 has a representative vector RV1 that represents another representative point within the vector space VS. Four vectors V5 to V8 belong to the cluster CL1. Each of the vectors V5 to V8 is a D-dimensional vector that is close to the representative vector RV1 of the cluster CL1. Arrows from the representative vector RV1 to each of the vectors V5 to V8 represent the differences (vector differences) between each of the vectors V5 to V8 and the representative vector RV1.

The cluster CL2 has a representative vector RV2 that represents yet another representative point within the vector space VS. Four vectors V9 to V12 belong to the cluster CL2. Each of the vectors V9 to V12 is a D-dimensional vector that is close to the representative vector RV2 of the cluster CL2. Arrows from the representative vector RV2 to each of the vectors V9 to V12 represent the differences (vector differences) between each of the vectors V9 to V12 and the representative vector RV2.

The cluster CL3 has a representative vector RV3 that represents yet another representative point within the vector space VS. Four vectors V13 to V16 belong to the cluster CL3. Each of the vectors V13 to V16 is a D-dimensional vector that is close to the representative vector RV3 of the cluster CL3. Arrows from the representative vector RV3 to each of the vectors V13 to V16 represent the differences (vector differences) between each of the vectors V13 to V16 and the representative vector RV3.

The cluster CL4 has a representative vector RV4 that represents yet another representative point within the vector space VS. Four vectors V17 to V20 belong to the cluster CL4. Each of the vectors V17 to V20 is a D-dimensional vector that is close to the representative vector RV4 of the cluster CL4. Arrows from the representative vector RV4 to each of the vectors V17 to V20 represent the differences (vector differences) between each of the vectors V17 to V20 and the representative vector RV4.

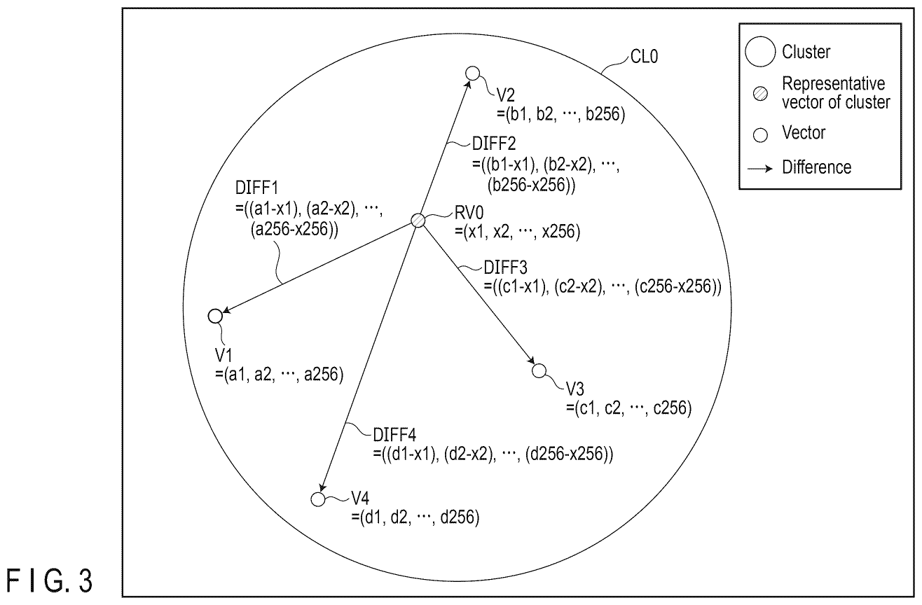

FIG. 3 is a diagram illustrating differences DIFF between vectors within a cluster and a representative vector of that cluster.

FIG. 3 is a diagram illustrating examples of differences DIFF1 to DIFF4 corresponding respectively to the vectors V1 to V4 belonging to the cluster CL0. In the following, a case where the number of dimensions D of each vector to be registered in the vector database 20 is 256 is described as an example.

For example, a case is assumed where vector V1=(a1, a2, . . . , a256), vector V2=(b1, b2, . . . , b256), vector V3=(c1, c2, . . . , c256), vector V4=(d1, d2, . . . , d256), and representative vector RV0 of cluster CL0=(x1, x2, . . . , x256).

The difference DIFF1 between the vector V1 and the representative vector RV0 of the cluster CL0 includes, as D elements of the difference DIFF1, D differences (here, (a1−x1), (a2−x2), . . . , (a256−x256)) obtained by subtracting D elements of the representative vector RV0 of the cluster CL0 (here, x1, x2, . . . , x256) from D elements of the vector V1 (here, a1, a2, . . . , a256), respectively. That is, the difference DIFF1 is expressed by the following equation.
DIFF1=((a1−x1), (a2−x2), . . . , (a256−x256))

Therefore, with respect to the vector V1, an identifier of the cluster CL0 and the difference DIFF1 (here, (a1−x1), (a2−x2), . . . , (a256−x256)) are stored in the vector database 20 as position information indicating the position of the vector V1 in the vector space VS.

The difference DIFF2 between the vector V2 and the representative vector RV0 of the cluster CL0 includes, as D elements of the difference DIFF2, D differences (here, (b1−x1), (b2−x2), . . . , (b256−x256)) obtained by subtracting D elements of the representative vector RV0 of the cluster CL0 (here, x1, x2, . . . , x256) from D elements of the vector V2 (here, b1, b2, . . . , b256), respectively. That is, the difference DIFF2 is expressed by the following equation.
DIFF2=((b1−x1), (b2−x2), . . . , (b256−x256))

Therefore, with respect to the vector V2, the identifier of cluster CL0 and the difference DIFF2 (here, (b1−x1), (b2−x2), . . . , (b256−x256)) are stored in the vector database 20 as position information indicating the position of the vector V2 in the vector space VS.

The difference DIFF3 between the vector V3 and the representative vector RV0 of the cluster CL0 includes, as D elements of the difference DIFF3, D differences (here, (c1−x1), (c2−x2), . . . , (c256−x256)) obtained by subtracting D elements of the representative vector RV0 of the cluster CL0 (here, x1, x2, . . . , x256) from D elements of the vector V3 (here, c1, c2, . . . , c256), respectively. That is, the difference DIFF3 is expressed by the following equation.
DIFF3=((c1−x1), (c2−x2), . . . , (c256−x256))

Therefore, with respect to the vector V3, the identifier of the cluster CL0 and the difference DIFF3 (here, (c1−x1), (c2−x2), . . . , (c256−x256)) are stored in the vector database 20 as position information indicating the position of the vector V3 in the vector space VS.

The difference DIFF4 between the vector V4 and the representative vector RV0 of the cluster CL0 includes, as D elements of the difference DIFF4, D differences (here, (d1−x1), (d2−x2), . . . , (d256−x256)) obtained by subtracting D elements of the representative vector RV0 of the cluster CL0 (here, x1, x2, . . . , x256) from D elements of the vector V4 (here, d1, d2, . . . , d256), respectively. That is, the difference DIFF4 is expressed by the following equation.
DIFF4=((d1−x1), (d2−x2), . . . , (d256−x256))

Therefore, with respect to the vector V4, the identifier of the cluster CL0 and the difference DIFF4 (here, (d1−x1), (d2−x2), . . . , (d256−x256)) are stored in the vector database 20 as position information indicating the position of the vector V4 in the vector space VS.

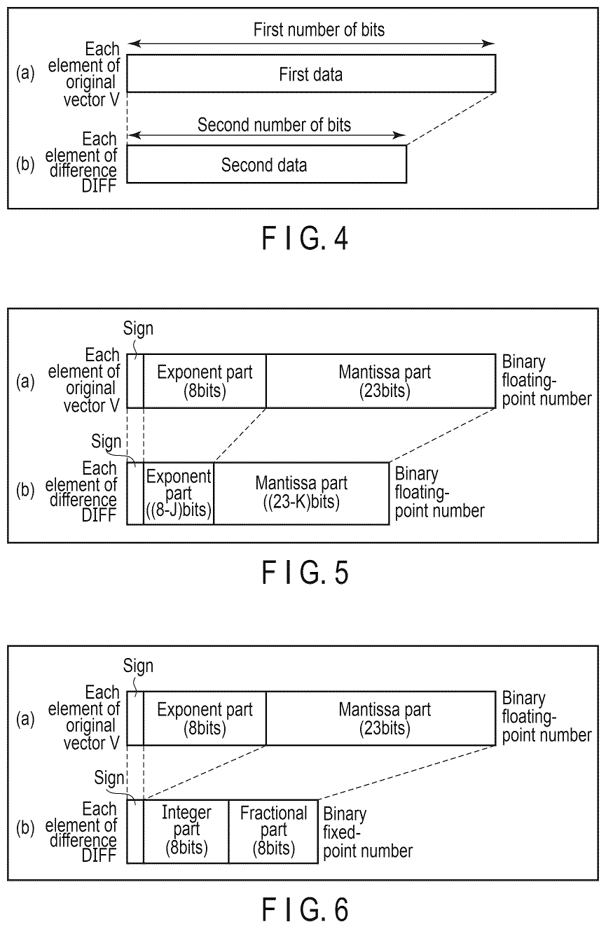

Next, with reference to FIG. 4 to FIG. 6, a data format for representing each element of the difference DIFF corresponding to each vector is described. In FIG. 4 to FIG. 6, each D-dimensional vector to be registered in the vector database 20 is represented as a full-precision original vector.

FIG. 4 is a diagram illustrating examples of the number of bits of data representing each element of an original vector V and the number of bits of data representing each element of the difference DIFF.

As shown in FIG. 4 (a), each of the D elements contained in the original vector V is represented by first data having a first number of bits. On the other hand, as shown in FIG. 4 (b), each of the D elements contained in the difference DIFF corresponding to the original vector V, i.e., each of the D differences obtained by subtracting the D elements of the representative vector from the D elements of the original vector V, respectively, is represented by second data having a second number of bits that is less than the first number of bits. Therefore, the size of the difference DIFF corresponding to the original vector V is smaller than the size of the original vector V.

FIG. 5 is a diagram illustrating examples of a floating-point number format representing each element of the original vector V and a floating-point number format representing each element of the difference DIFF.

As shown FIG. 5 (a), the first data representing each element of the original vector V is a bit string for floating-point number (binary floating-point number) including, for example, a 1-bit sign indicating positive or negative, an exponent part having a third number of bits (e.g., 8 bits), and a mantissa part having a fourth number of bits (e.g., 23 bits). The exponent part is used to scale the numerical value of the mantissa part using powers of two. The larger the number of bits in the exponent part, the larger the representable numerical value.

On the other hand, as shown in FIG. 5 (b), the second data representing each element of the difference DIFF corresponding to the original vector V is a bit string for floating-point number (binary floating-point number) including a 1-bit sign indicating positive or negative, an exponent part having a fifth number of bits (e.g., (8−J) bits) which is less than the third number of bits, and a mantissa part having a sixth number of bits (e.g., (23−K) bits) which is less than the fourth number of bits. J is an integer of one or greater, and K is an integer of one or greater. Since an absolute value of each element (numerical value) of the difference DIFF is smaller than an absolute value of each element (numerical value) of the original vector V, most of the number of bits in the 8-bit exponent part are wasted in a case of storing the difference DIFF. Therefore, as shown in FIG. 5 (b), the number of bits in the exponent part can be reduced. Additionally, for small numerical values, values corresponding to lower bits of the mantissa part are extremely small values including zero. Therefore, in the case of storing the difference DIFF, the number of bits in the mantissa part can also be reduced.

FIG. 6 is a diagram illustrating examples of a floating-point number format representing each element of the original vector V and a fixed-point number format representing each element of the difference DIFF.

As shown in FIG. 6 (a), the first data representing each element of the original vector V has a 32-bit floating-point number format described in FIG. 5 (a).

On the other hand, as shown in FIG. 6 (b), the second data representing each element of the difference DIFF corresponding to the original vector V is a bit string for fixed-point number (binary fixed-point number) that includes a 1-bit sign, an integer part with a seventh number of bits, and a fractional part with an eighth number of bits, and does not include an exponent part. The sum of the seventh number of bits and the eighth number of bits may, for example, be equal to or less than the number of bits of the mantissa part of the original vector V (the fourth number of bits). FIG. 6 (b) shows an example of a case where each of the integer part and the fractional part are 8 bits. Since the absolute value of each element (numerical value) of the difference DIFF is smaller than the absolute value of each element (numerical value) of the original vector, the difference DIFF can be represented in a fixed-point number format, which has fewer bits than the 32-bit floating-point number format.

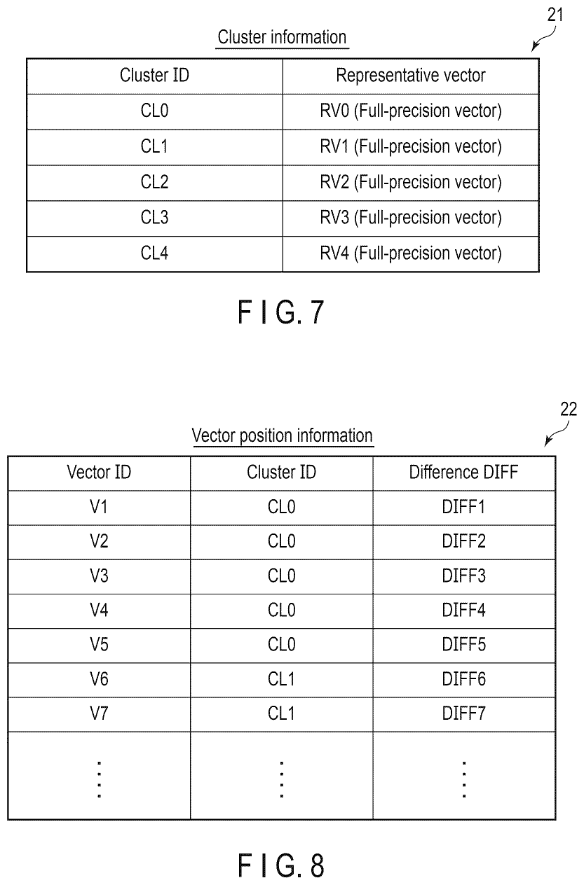

FIG. 7 is a diagram illustrating an example of the cluster information 21 managed in the information processing system 1 according to the first embodiment.

The cluster information 21 includes a plurality of entries corresponding respectively to a plurality of clusters. Each of the plurality of entries includes a cluster ID field and a representative vector field.

The cluster ID field indicates an identifier (cluster ID) assigned to a corresponding cluster. The representative vector field indicates a representative vector of a corresponding cluster. The representative vector is represented by a full-precision vector. That is, each of the D elements contained in the representative vector is represented by the first data (e.g., the 32-bit floating-point number format shown in FIG. 5 (a) or FIG. 6 (a)) in the same manner as each of the D elements contained in each D-dimensional vector.

FIG. 8 is a diagram illustrating an example of the vector position information 22 managed in the information processing system 1 according to the first embodiment.

The vector position information 22 includes a plurality of entries corresponding respectively to a plurality of D-dimensional vectors. Each of the plurality of entries includes a vector ID field, a cluster ID field, and a difference DIFF field.

The vector ID field indicates an identifier (vector ID) assigned to a corresponding D-dimensional vector. The cluster ID field indicates an identifier (cluster ID) assigned to a cluster to which the corresponding D-dimensional vector belongs. The difference DIFF field indicates the difference DIFF between the corresponding D-dimensional vector and a representative vector of the cluster to which the corresponding D-dimensional vector belongs, i.e., the D differences obtained by subtracting the D elements of the representative vector of the cluster, to which the corresponding D-dimensional vector belongs, from the D elements of the corresponding D-dimensional vector, respectively. Each of the D elements of the difference DIFF, i.e., each of the D differences, is represented by the second data having smaller number of bits than the bit number of bits of the first data (e.g., the floating-point number format shown in FIG. 5 (b) or the fixed-point number format shown in FIG. 6 (b)).

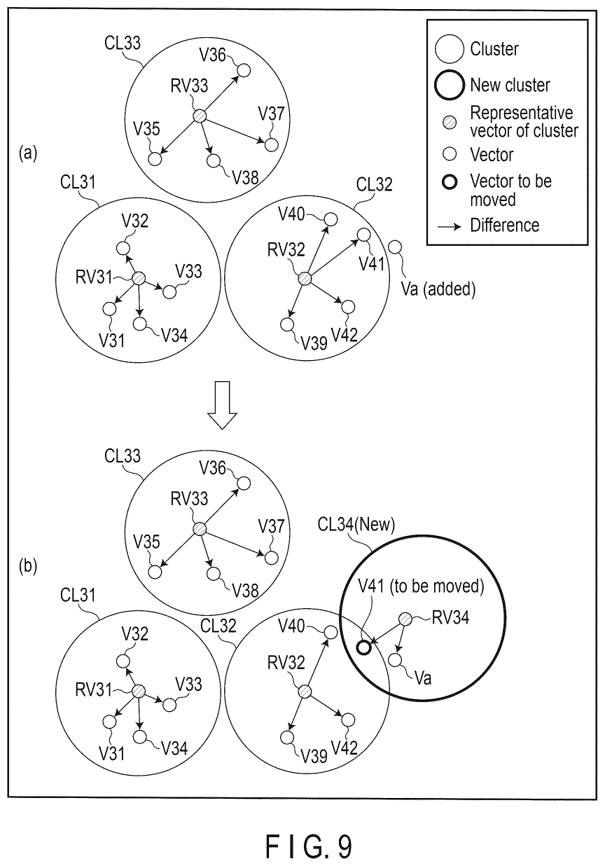

Next, the cluster-to-cluster vector movement processing is described. FIG. 9 is a diagram illustrating an example of the cluster-to-cluster vector movement processing executed in the information processing system 1 according to the first embodiment.

The cluster-to-cluster vector movement processing is processing of moving a certain D-dimensional vector from an existing cluster to a new cluster when the new cluster is generated. The generation of a new cluster may be executed, for example, in a case where the number of vectors already belonging to a cluster closest to a new vector to be added reaches an upper limit, or in a case where the new vector to be added is a remote vector.

For example, as shown in FIG. 9 (a), a case is assumed in which a new vector Va is added to the vector database 20 in a state where three clusters CL31 to CL33 are being managed.

Among the three clusters CL31 to CL33, the cluster with a representative vector closest to the new vector Va is the cluster CL32. The representative vector of the cluster CL32 is a representative vector RV32, and vectors V39 to V42 belong to the cluster CL32. In a case where the maximum number of vectors that can belong to each cluster is four, the new vector Va cannot be added to the cluster CL32.

Therefore, as shown in FIG. 9 (b), the processor 11 generates a new cluster CL34 having a representative vector RV34. The representative vector RV34 of the new cluster CL34 may be a vector indicating a position close to the new vector Va, for example.

The processor 11 calculates the difference DIFF between the new vector Va and the representative vector RV34 (i.e., D differences obtained by subtracting D elements contained in the representative vector RV34 from D elements contained in the new vector Va, respectively), and stores an identifier (cluster ID) of the new cluster CL34 and the calculated difference DIFF (D differences) as position information of the new vector Va in the vector database 20.

In addition, the processor 11 identifies, from among the vectors V39 to V42 belonging to the cluster CL32 close to the representative vector RV34 of the new cluster CL34, a vector (a second D-dimensional vector) whose distance to the representative vector RV34 of the new cluster CL34 is shorter than its distance to the representative vector RV32 of the cluster CL32. In FIG. 9 (b), the vector V41 belonging to the cluster CL32 is identified as the second D-dimensional vector.

Then, the processor 11 executes movement processing to move the vector V41 from the cluster CL32 to the new cluster CL34.

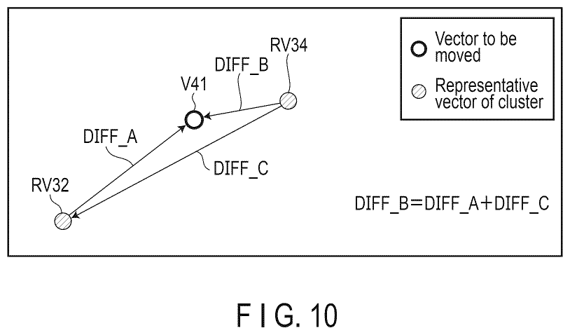

When executing the movement processing, as shown in FIG. 10, the processor 11 acquires a difference DIFF_A between the vector V41 and the representative vector RV32 of the cluster CL32 to which the vector V41 belongs (i.e., D differences obtained by subtracting the D elements contained in the representative vector RV32 of the cluster CL32 from the D elements contained in the vector V41, respectively) from the vector position information 22 of the vector database 20. The difference DIFF_A is a vector difference between the vector V41 and the representative vector RV32, i.e., (V41−RV32).

Next, the processor 11 calculates a difference DIFF_C between the representative vector RV32 of the cluster CL32 and the representative vector RV34 of the new cluster CL34 (i.e., D differences obtained by subtracting the D elements contained in the representative vector RV34 from the D elements contained in the representative vector RV32, respectively). The difference DIFF_C is a vector difference between the representative vector RV32 and the representative vector RV34, i.e., (RV32−RV34).

Then, the processor 11 adds the difference DIFF_C to the difference DIFF_A to calculate a difference DIFF_B between the vector V41 and the representative vector RV34 (i.e., D differences obtained by subtracting the D elements contained in the representative vector RV34 of the new cluster CL34 from the D elements contained in the vector V41, respectively). That is, since DIFF_A+DIFF_C=(V41−RV32)+(RV32−RV34)=(V41−RV34), the difference DIFF_B(=V41−RV34) can be calculated by adding the difference DIFF_C to the difference DIFF_A.

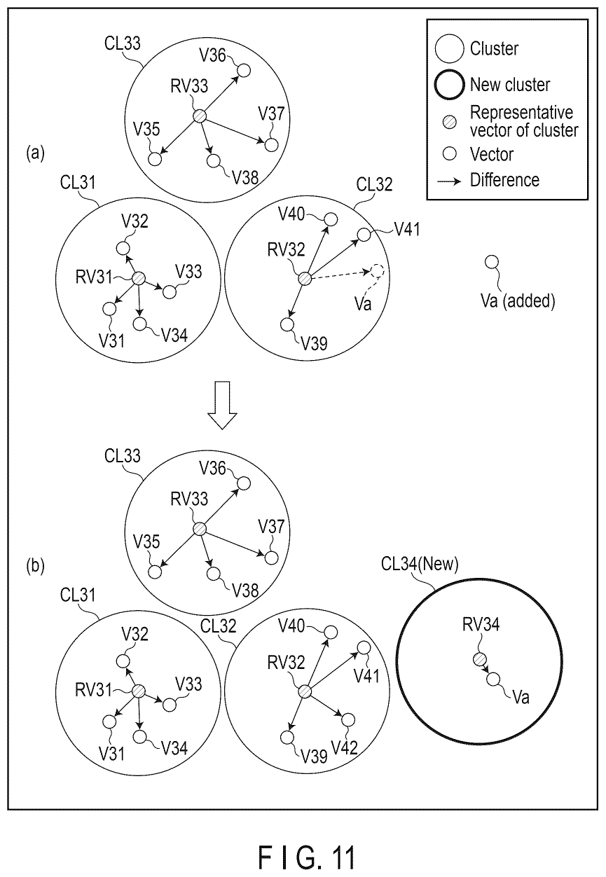

Next, remote vector registration processing is described. FIG. 11 is a diagram illustrating an example of remote vector addition processing executed in the information processing system 1 according to the first embodiment.

For example, as shown in FIG. 11 (a), a case is assumed in which a new vector Va is added to the vector database 20 in a state where three clusters CL31 to CL33 are being managed. The new vector Va is a remote vector whose distance to all representative vectors of the plurality of clusters (here, representative vectors RV31 to RV33 of clusters CL31 to CL33) exceeds a maximum value of difference that is expressible by the second data.

The cluster with the representative vector closest to the new vector Va is cluster CL32. However, the absolute value of each of the D differences obtained by subtracting D elements of the representative vector RV32 of the cluster CL32 from D elements of the new vector Va, respectively, exceeds the maximum value of the difference that can be expressed by the second data. Therefore, if the new vector Va was registered in the cluster CL32, as shown by the dashed line in FIG. 11 (a), the absolute value of each of the D differences obtained by subtracting the D elements of the representative vector RV32 of the cluster CL32 from the D elements of the new vector Va, respectively, would be significantly reduced from the actual value of each of the D differences. As a result, the error of each of these D differences will become large.

Therefore, as shown in FIG. 11 (b), the processor 11 generates a new cluster CL34 having a representative vector RV34 that is close to the new vector Va. The representative vector RV34 may be a vector indicating the same position as the new vector Va in the vector space VS.

Next, the processor 11 calculates D fourth differences obtained by subtracting the D elements contained in the representative vector RV34 of the new cluster CL34 from the D elements contained in the new vector Va, respectively. Then, the processor 11 stores an identifier of the new cluster CL34 and the D fourth differences as information indicating the position of the new vector Va in the vector space VS in the vector database 20.

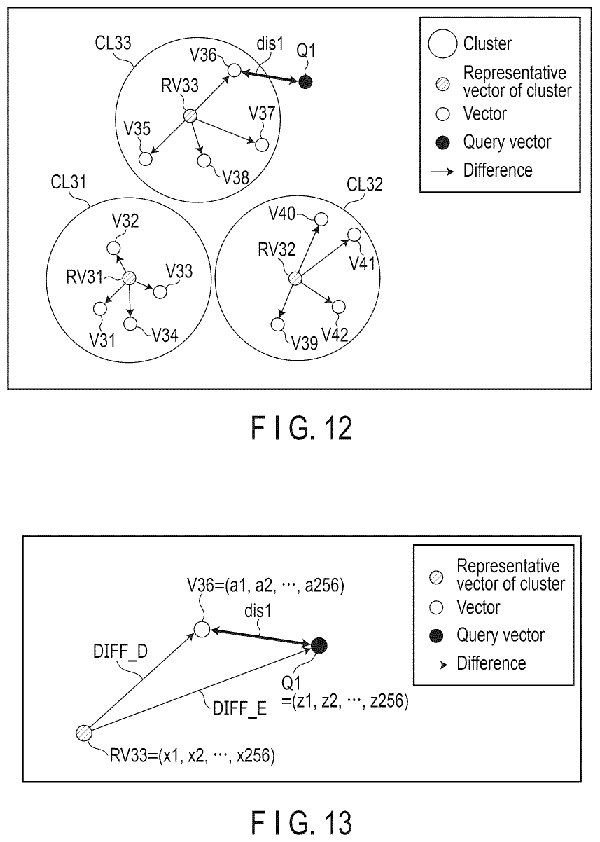

Next, distance calculation processing is explained with reference to FIG. 12 and FIG. 13. FIG. 12 is a diagram illustrating an example of vectors subject to distance calculation. FIG. 13 is a diagram illustrating an example of the distance calculation processing for calculating a distance between a vector subject to the distance calculation and a query vector.

In FIG. 12 and FIG. 13, a case where a distance dis1 between a query vector Q1 and a vector V36 in the cluster CL33 is calculated is assumed.

As shown in FIG. 13, in the distance calculation processing for calculating the distance dis1, a difference DIFF_D between the vector V36 and the representative vector RV33 of the cluster CL33 (i.e., D fifth differences obtained by subtracting D elements of the representative vector RV33 from D elements of the vector V36, respectively) is acquired from the vector database 20. In a case where V36=(a1, a2, . . . , a256), RV33=(x1, x2, . . . , x256), the difference DIFF_D is expressed by the following equation.
DIFF_D=((a1−x1), (a2−x2), . . . , (a256−x256))

Here, (a1−x1), (a2−x2), . . . , (a256−x256) are the D fifth differences.

Next, a difference DIFF_E between the query vector Q1 and the representative vector RV33 (i.e., D sixth differences obtained by subtracting the D elements of the representative vector RV33 from D elements of the query vector Q1, respectively) is calculated. In a case where Q1=(z1, z2, . . . , z256), the difference DIFF_E is expressed by the following equation.
DIFF_E=((z1−x1), (z2−x2), . . . , (z256−x256))

Here, (z1−x1), (z2−x2), . . . , (z256−x256) are the D sixth differences.

Then, the sum of squares of D seventh differences (squared distance) between the D fifth differences ((a1−x1), (a2−x2), . . . , (a256−x256)) contained in the DIFF_D and the D sixth differences ((z1−x1), (z2−x2), . . . , (z256−x256)) contained in a DIFF_E, or the square root of the sum of squares (Euclidean distance) is calculated as the distance dis1.

The D seventh differences are (a1−x1)−(z1−x1), (a2−x2)−(z2−x2), . . . , (a256−x256)−(z256−x256). The sum of squares of the D seventh differences is expressed by the following equation.
((a1−x1)−(z1−x1))²+((a2−x2)−(z2−x2))²+ . . . +((a256−x256)−(z256−x256))²

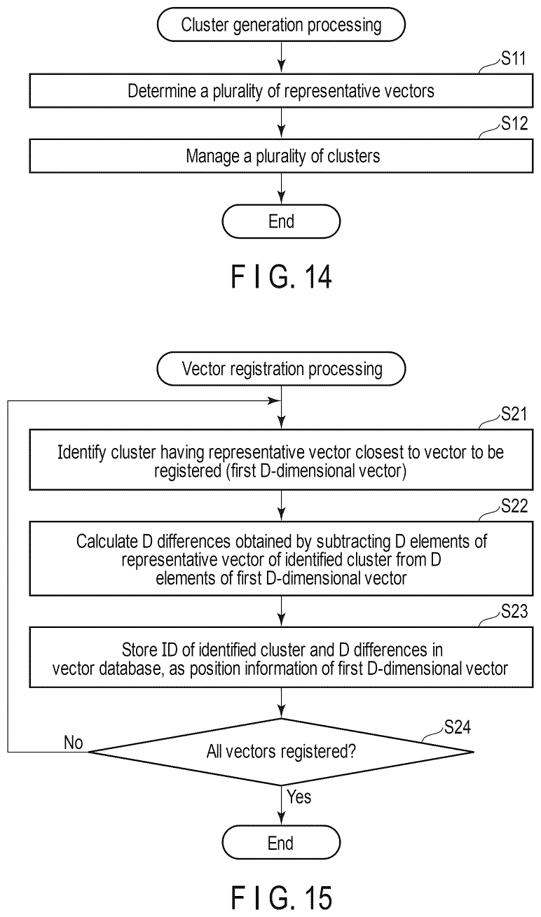

Next, a procedure for cluster generation processing is described. FIG. 14 is a flowchart illustrating an example of the procedure for cluster generation processing executed in the information processing system 1 according to the first embodiment. The cluster generation processing is processing of generating a plurality of clusters, each of which has a representative vector that indicates a representative point in the vector space VS and has D dimensions.

The processor 11 determines a plurality of representative vectors, each of which indicates a representative point in the vector space VS (step S11). Methods for determining the plurality of representative vectors include, for example, the k-means method or other various methods. Then, the processor 11 generates the cluster information 21 based on the determined plurality of representative vectors and manages the plurality of clusters, each having a determined representative point, using the cluster information 21 (step S12).

Through the above cluster generation processing, the processor 11 can manage a plurality of clusters, each of which has a representative vector that indicates a representative point in the vector space VS and has D dimensions.

Next, a procedure for vector registration processing is described. FIG. 15 is a flowchart illustrating an example of the procedure for vector registration processing executed in the information processing system 1 according to the first embodiment. The vector registration processing is processing of registering each of a plurality of vectors (D-dimensional vectors) in the vector database 20.

The processor 11 identifies a cluster among the plurality of clusters that has a representative vector closest to a vector to be registered (first D-dimensional vector) (step S21). Next, the processor 11 calculates D differences obtained by subtracting D elements of the representative vector of the identified cluster from D elements of the first D-dimensional vector, respectively (step S22). Then, the processor 11 stores an ID of the identified cluster and the calculated D differences as position information of the first D-dimensional vector in the vector database 20 (step S23). In this case, the processor 11 stores each of the D differences in a data format having number of bits less than the number of bits of data representing each of the D elements of the first D-dimensional vector in the vector database 20.

The processor 11 determines whether or not all vectors to be registered have been registered in the vector database 20 (step S24). In a case where all vectors to be registered have been registered in the vector database 20 (step S24, Yes), the processor 11 ends the vector registration processing. In a case where there are any unregistered vectors remaining among the vectors to be registered (step S24, No), the processor 11 executes the processing of steps S21 to S23 for the next vector to be registered.

Through the above vector registration processing, the processor 11 can store the difference (vector difference) between the first D-dimensional vector and the representative vector of the cluster to which the first D-dimensional vector belongs as position information indicating the position of the first D-dimensional vector within the vector space VS in the vector database 20.

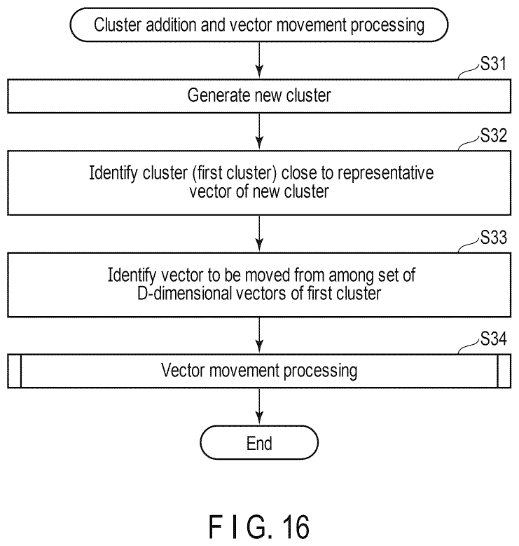

Next, a procedure for cluster addition and vector movement processing is described. FIG. 16 is a flowchart illustrating an example of the procedure for cluster addition and vector movement processing executed in the information processing system 1 according to the first embodiment., The cluster addition and vector movement processing is a process of moving a vector close to a representative vector of the new cluster from a cluster to which this vector belongs to the new cluster when a new cluster is generated.

For example, in a case where a new vector is added and the number of vectors belonging to a cluster closest to the new vector reaches an upper limit, or in a case where the new vector is a remote vector, the processor 11 generates a new cluster having a representative vector indicating a representative point in the vector space VS (step S31).

The processor 11 identifies, from among the plurality of clusters that have already been generated, a cluster (first cluster) that has a representative vector close to the representative vector of the new cluster (step S32).

The processor 11 identifies a vector to be moved from among the set of vectors (D-dimensional vectors) belonging to the first cluster (step S33). The vector to be moved is a vector (second D-dimensional vector) whose distance to the representative vector of the new cluster is shorter than the distance to the representative vector of the first cluster. Then, processor 11 executes the vector movement processing to move the second D-dimensional vector from the first cluster to the new cluster (step S34), and ends the cluster addition and vector movement processing.

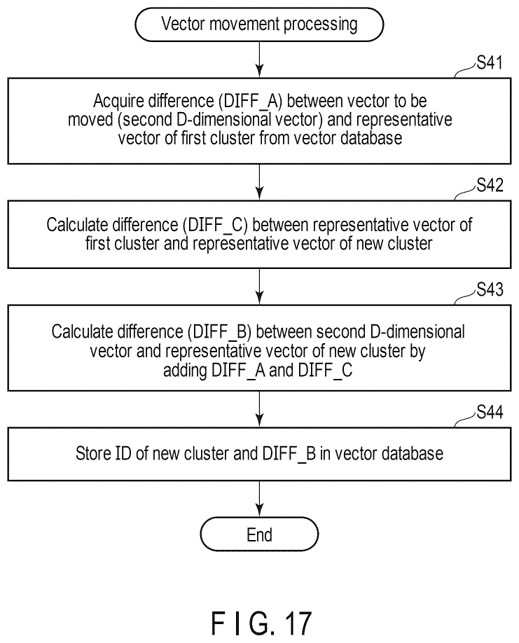

FIG. 17 is a flowchart illustrating an example of a procedure for vector movement processing executed in the information processing system 1 according to the first embodiment. In step S34 of FIG. 16, the vector movement processing described below is executed.

The processor 11 acquires a difference (referred to as DIFF_A) between the vector to be moved (the second D-dimensional vector) and the representative vector of the first cluster from the vector database 20 (step S41). The DIFF_A is information stored in the vector database 20 as position information of the second D-dimensional vector, and includes, as D elements of the DIFF_A, D first differences obtained by subtracting D elements of the representative vector of the first cluster from D elements of the second D-dimensional vector, respectively.

The processor 11 calculates a difference (referred to as DIFF_C) between the representative vector of the first cluster and the representative vector of the new cluster (step S42). The DIFF_C includes, as D elements of DIFF_C, D second differences obtained by subtracting D elements of the representative vector of the new cluster from the D elements of the representative vector of the first cluster, respectively.

The processor 11 calculates a difference (referred to as DIFF_B) between the second D-dimensional vector and the representative vector of the new cluster by adding DIFF_A and DIFF_C for each corresponding element (step S43). That is, in step S43, the processor 11 calculates D third differences obtained by adding the D second differences respectively to the D first differences. The D third differences are D elements of DIFF_B.

The processor 11 stores an ID of the new cluster and DIFF_B (the D third differences) in the vector database 20 as information indicating the position of the second D-dimensional vector in the vector space VS (step S44), and then ends the vector movement processing. By step S44, the cluster ID corresponding to the second D-dimensional vector is updated from the ID of the first cluster to the ID of the new cluster, and the difference DIFF corresponding to the second D-dimensional vector is updated from DIFF_A to DIFF_B.

Through the above vector movement processing, the processor 11 can update the difference DIFF corresponding to the second D-dimensional vector from DIFF_A to DIFF_B without restoring the difference DIFF_A corresponding to the second D-dimensional vector to the original D-dimensional vector. For example, in a case where each of the D elements of each D-dimensional vector is represented in the floating-point number format and each of the D elements of each DIFF is represented in the fixed-point number format, the difference DIFF corresponding to the second D-dimensional vector can be updated from DIFF_A to DIFF_B using only fixed-point operations, without executing floating-point operations, which has high computational costs.

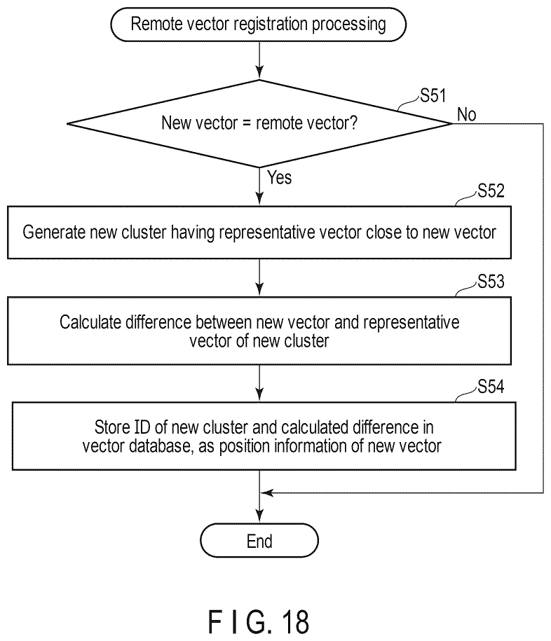

Next, a procedure for remote vector registration processing is described. FIG. 18 is a flowchart illustrating an example of the procedure for remote vector registration processing executed in the information processing system 1 according to the first embodiment. The remote vector registration processing is processing for reducing an error of a difference DIFF corresponding to a new vector to be added in a case where the new vector is a remote vector.

The processor 11 determines whether or not the new vector to be added is a remote vector based on the representative vectors of each cluster that is already generated and the added new vector (step S51).

In a case where the new vector is determined not to be a remote vector (step S51, No), the processor 11 ends the remote vector registration processing.

In a case where the new vector is determined to be a remote vector (step S51, Yes), the processor 11 generates a new cluster that has a representative vector adjacent to the new vector (step S52).

The processor 11 calculates a difference between the new vector and the representative vector of the new cluster, i.e., D fourth differences obtained by subtracting D elements contained in the representative vector of the new vector from D elements contained in the new vector, respectively (step S53).

The processor 11 stores an ID of the new cluster and the calculated difference (D fourth differences) as information representing the position of the new vector in vector space VS in the vector database 20 (step S54), and then ends the remote vector registration processing.

Through the above remote vector registration processing, the processor 11 can reduce the error contained in the differences stored as remote vector position information.

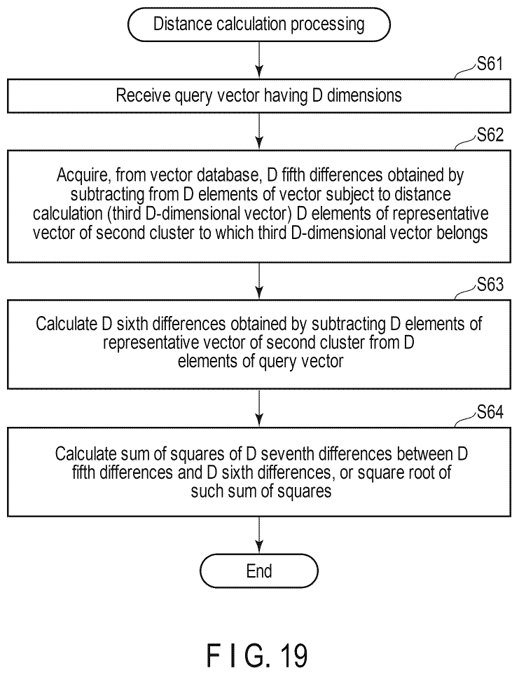

Next, a procedure for distance calculation processing is described. FIG. 19 is a flowchart illustrating an example of the procedure for the distance calculation processing executed in the information processing system 1 according to the first embodiment. The distance calculation processing is processing of calculating a distance between each vector subject to distance calculation and a query vector. Here, a case is assumed in which the vector subject to distance calculation is the third D-dimensional vector.

The processor 11 receives a query vector having D dimensions based on a query from the external device 2 (step S61).

The processor 11 acquires, from the vector database 20, D fifth differences obtained by subtracting D elements of the representative vector of the cluster (second cluster), to which the vector subject to distance calculation (third D-dimensional vector) belongs, from D elements of the third D-dimensional vector, respectively (step S62).

The processor 11 calculates D sixth differences obtained by subtracting the D elements of the representative vector of the second cluster from D elements of the query vector, respectively (step S63).

The processor 11 calculates the sum of squares of D seventh differences between the D fifth differences and the D sixth differences, or the square root of the sum of squares, as the distance between the third D-dimensional vector and the query vector (step S64), and ends the distance calculation processing.

Through the above distance calculation processing, the processor 11 can calculate the distance between the third D-dimensional vector and the query vector without restoring the differences (D fifth differences) corresponding to the third D-dimensional vector to the original D-dimensional vector.

As described above, according to the first embodiment, when registering a certain vector (first D-dimensional vector) in the vector database 20, a cluster having a representative vector closest to the first D-dimensional vector is identified, and D differences obtained by subtracting the D elements contained in the representative vector of the identified cluster from the D elements contained in the first D-dimensional vector, respectively, are calculated. Then, the identifier of the identified cluster and the calculated D differences are stored in the vector database 20 as position information (vector position information 22) indicating the position of the first D-dimensional vector in the D-dimensional vector space. Since an absolute value of each of the D differences is much smaller than an absolute value of each element of the first D-dimensional vector, the number of bits of data representing each of the D differences can be reduced to fewer number of bits than the number of bits of data representing each element of the original vector (here, the first D-dimensional vector).

Therefore, compared to a case of storing each original vector (full-precision vector) itself as the vector position information 22 in the vector database 20, the amount of data of the vector set (size of the vector position information 22) stored in the vector database 20 can be reduced.

Furthermore, the distance between a vector belonging to a certain cluster and a query vector can be correctly calculated using D differences between the query vector and the representative vector of the cluster and D differences corresponding to this vector.

Therefore, without storing each D-dimensional vector itself as the vector position information 22 in the vector database 20, it is possible to achieve search accuracy equivalent to that obtained in a case where each D-dimensional vector itself is stored in the vector database 20 as the vector position information 22.

Therefore, it is possible to reduce the amount of data of the vector set stored in the vector database while suppressing a decrease in search accuracy.

### Second Embodiment

Next, as a second embodiment, processing is described in which a plurality of clusters are managed for each of a plurality of subvector spaces obtained by dividing a vector space VS, each D-dimensional vector is divided into a plurality of subvectors, and a difference between the subvectors and a representative vector of a cluster to which the subvectors belongs is stored as position information of the subvector.

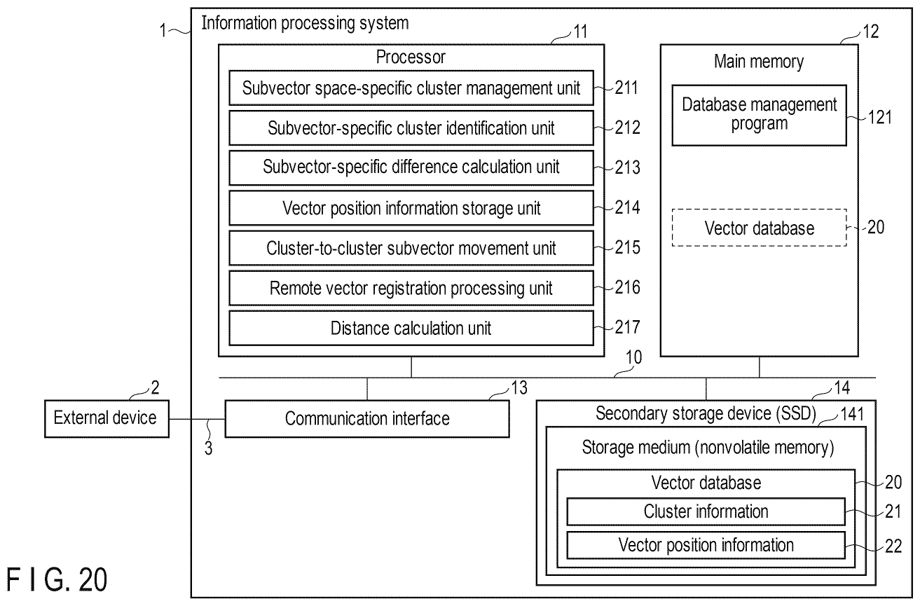

FIG. 20 is a block diagram illustrating a configuration example of an information processing system 1 according to the second embodiment. In the information processing system 1 according to the second embodiment, only the functional configuration of a processor 11 differs from that of the first embodiment, and the other configurations are basically the same as those of the first embodiment.

Next, the functional configuration of the processor 11 of the information processing system 1 according to the second embodiment is described.

By executing a database management program 121, the processor 11 functions as a subvector space-specific cluster management unit 211, a subvector-specific cluster identification unit 212, a subvector-specific difference calculation unit 213, a vector position information storage unit 214, a cluster-to-cluster subvector movement unit 215, a remote vector registration processing unit 216, and a distance calculation unit 217. Note that each of these units may be implemented by dedicated hardware (circuits) within the information processing system 1.

The subvector space-specific cluster management unit 211 manages a plurality of clusters for each of R subvector spaces, each having D/R dimensions, obtained by dividing the vector space VS (D-dimensional vector space). R is an integer less than D and equal to or greater than two. Each of the plurality of clusters included in each of the R subvector spaces has a representative vector that indicates a representative point within a corresponding subvector space and has D/R dimensions.

When registering a certain vector (first D-dimensional vector) in a vector database 20, the subvector-specific cluster identification unit 212 divides the first D-dimensional vector into R subvectors, each having D/R dimensions. Then, for each of the R subvectors, the subvector-specific cluster identification unit 212 identifies a cluster that has a representative vector closest to the subvector among the plurality of clusters of the subvector space corresponding to the subvector, as the cluster to which the subvector should belong.

The subvector-specific difference calculation unit 213 calculates D/R differences, for each of the R subvectors of the first D-dimensional vector, which are obtained by subtracting D/R elements contained in the representative vector of the identified cluster from D/R elements contained in the subvector, respectively. These D/R differences are D/R elements included in the vector difference between the subvector and the representative vector of the identified cluster. The vector difference between the subvector and the representative vector of the specified cluster, i.e., the D/R differences obtained by subtracting the D/R elements contained in the representative vector of the identified cluster from the D/R elements contained in the subvector, respectively, is also referred to as a difference DIFF.

The vector position information storage unit 214 stores in the vector database 20, for each of the R subvectors of the first D-dimensional vector, an identifier of the identified cluster and the calculated D/R differences (i.e., the difference DIFF between the subvector and the representative vector of the identified cluster) as position information (vector position information 22) indicating the position of the subvector in the corresponding subvector space.

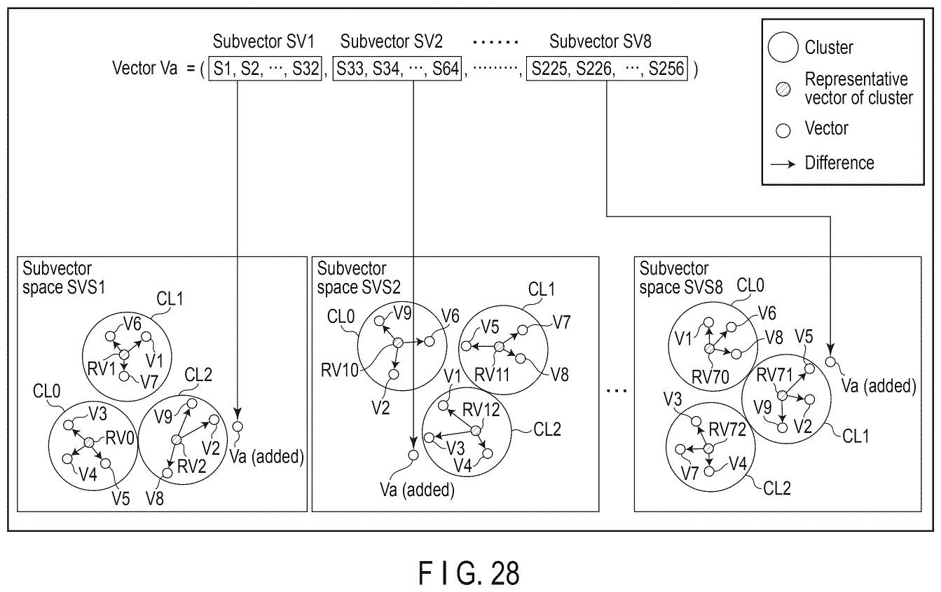

The cluster-to-cluster subvector movement unit 215 executes cluster-to-cluster subvector movement processing. The cluster-to-cluster subvector movement processing is processing of executing the cluster-to-cluster vector movement processing of the first embodiment for each subvector. Details of the cluster-to-cluster subvector movement processing are described below with reference to FIG. 28 to FIG. 30.

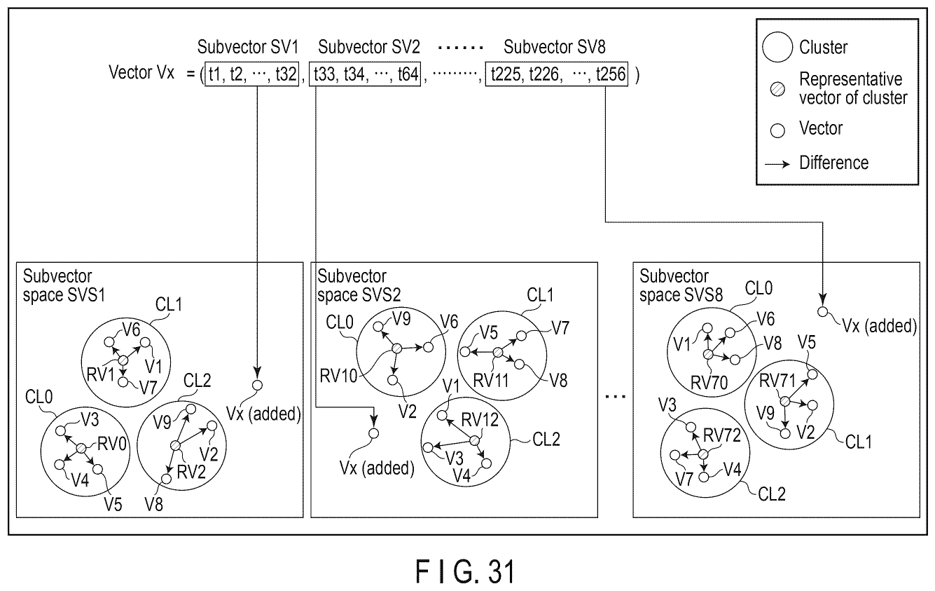

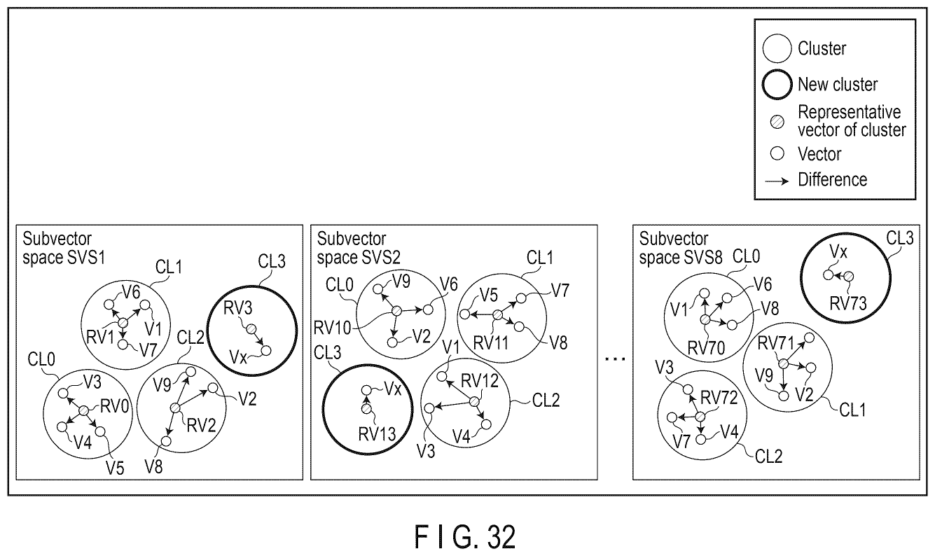

The remote vector registration processing unit 216 executes processing of reducing an error at the time of registration of each subvector included in a remote vector. In the second embodiment, the remote vector is a vector whose distance to all representative vectors of the plurality of clusters included in at least one of R subvector spaces exceeds a maximum value of difference that is expressible by second data. Details of the remote vector registration processing in the second embodiment are described below with reference to FIG. 31 and FIG. 32.

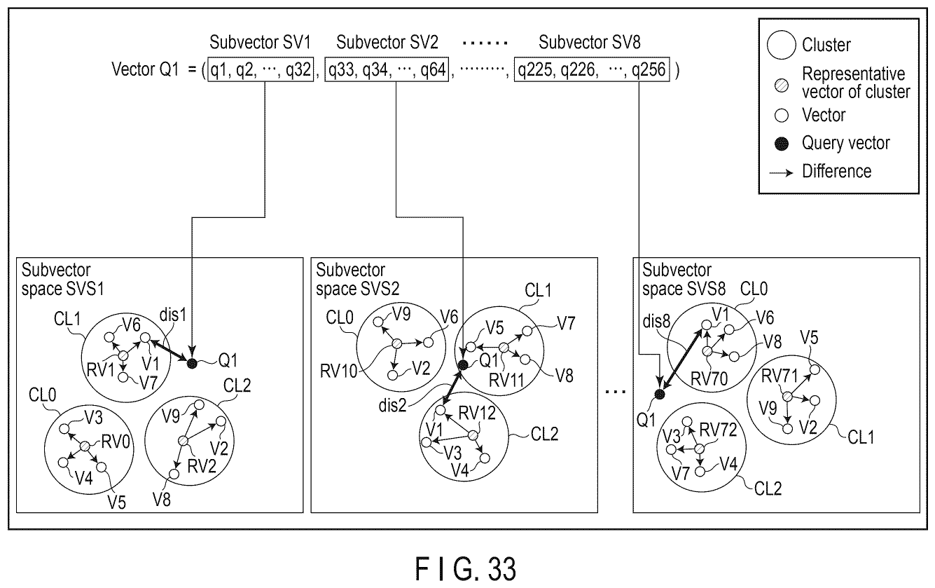

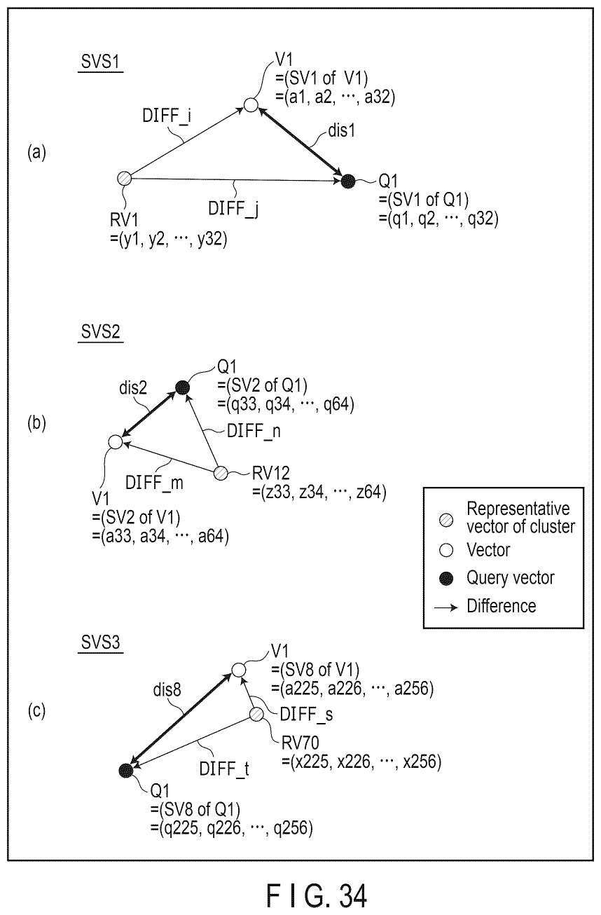

The distance calculation unit 217 calculates, when a D-dimensional query vector is given, a distance (Euclidean distance) between a vector subject to distance calculation (third D-dimensional vector) and the query vector. Details of the distance calculation in the second embodiment is described below with reference to FIG. 33 and FIG. 34.

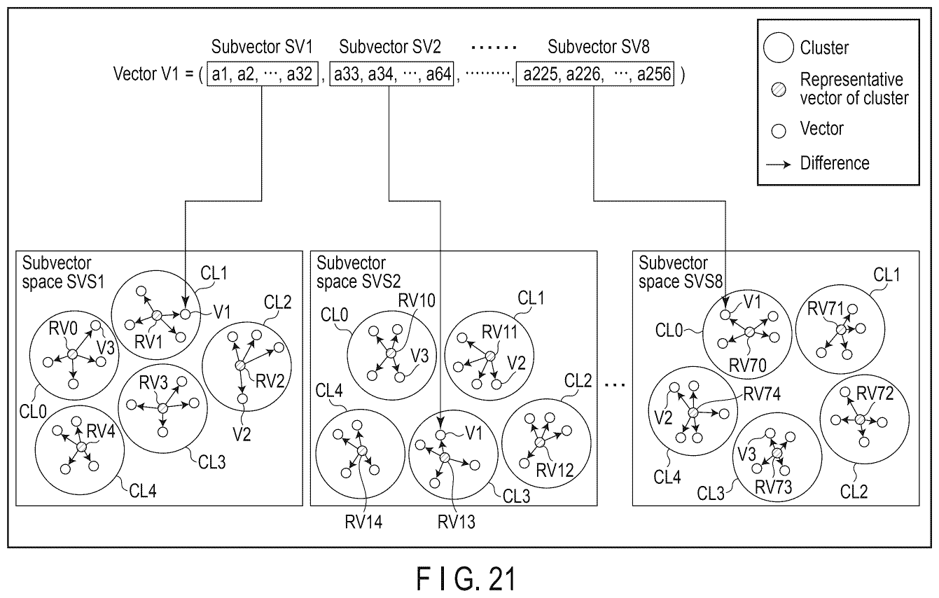

Next, a plurality of clusters managed for each subvector space are described. FIG. 21 is a diagram illustrating an example of the plurality of clusters managed for each subvector space in the information processing system 1 according to the second embodiment.

Here, a case is assumed in which each D-dimensional vector is divided into R subvectors. Furthermore, here, a case where the number of dimensions D is 256, the number of subvectors R is eight, and the number of dimensions per subvector D/R is 32 is described as an example.

For example, a D-dimensional vector V1(=a1, a2, . . . , a256) is divided into R subvectors (here, eight subvectors SV1, SV2, . . . , SV8), each containing D/R elements (here, 32 elements). Each of the other D-dimensional vectors is also divided into eight subvectors SV1, SV2, . . . , SV8 in the same manner as the D-dimensional vector V1.

The vector space (D-dimensional vector space) SV is divided into R subvector spaces SVS (here, eight subvector spaces SVS1, SVS2, . . . , SVS8), each having D/R dimensions (here, 32 dimensions).

A plurality of clusters are managed for each of the subvector spaces SVS1 to SVS8. FIG. 21 is a diagram illustrating a case where five clusters CL0 to CL4 are managed for each subvector space SVS as an example. In other words, in the second embodiment, each of the plurality of clusters described in the first embodiment is divided into a cluster of the subvector space SVS1, a cluster of the subvector space SVS2, . . . , and a cluster of the subvector space SVS8.

The cluster CL0 of the subvector space SVS1 has a representative vector RV0 representing a representative point within the subvector space SVS1. The cluster CL1 of the subvector space SVS1 has a representative vector RV1 representing another representative point within the subvector space SVS1. The cluster CL2 of the subvector space SVS1 has a representative vector RV2 representing yet another representative point within the subvector space SVS1. The cluster CL3 of the subvector space SVS1 has a representative vector RV3 representing yet another representative point within the subvector space SVS1. The cluster CL4 of the subvector space SVS1 has a representative vector RV4 representing yet another representative point within the subvector space SVS1. The number of dimensions of each of the representative vectors RV0 to RV4 is D/R.

The cluster CL0 of the subvector space SVS2 has a representative vector RV10 representing a representative point within the subvector space SVS2. The cluster CL1 of the subvector space SVS2 has a representative vector RV11 representing another representative point within the subvector space SVS2. The cluster CL2 of the subvector space SVS2 has a representative vector RV12 representing yet another representative point in the subvector space SVS2. The cluster CL3 of the subvector space SVS2 has a representative vector RV13 representing yet another representative point in the subvector space SVS2. The cluster CL4 of the subvector space SVS2 has a representative vector RV14 representing yet another representative point within the subvector space SVS2. The number of dimensions of each of the representative vectors RV10 to RV14 is D/R.

The cluster CL0 of the subvector space SVS8 has a representative vector RV70 representing a representative point within the subvector space SVS8. The cluster CL1 of the subvector space SVS8 has a representative vector RV71 representing another representative point within the subvector space SVS8. The cluster CL2 of the subvector space SVS8 has a representative vector RV72 representing yet another representative point within the subvector space SVS8. The cluster CL3 of the subvector space SVS8 has a representative vector RV73 representing yet another representative point within the subvector space SVS8. The cluster CL4 of the subvector space SVS8 has a representative vector RV74 representing yet another representative point within the subvector space SVS8. The number of dimensions of each of the representative vectors RV70 to RV74 is D/R.

For example, the vector registration processing for registering the D-dimensional vector V1 in the vector database 20 is described.

First, the D-dimensional vector V1 is divided into R subvectors SV (in this case, eight subvectors SV1 to SV8). Next, for each of the R subvectors SV, a cluster that has the representative vector closest to the subvector SV, among the plurality of clusters (here, clusters CL0 to CL4) of the subvector space SVS corresponding to the subvector SV is identified as the cluster to which the subvector SV should belong.

For example, in the subvector space SVS1, the cluster CL1 of the subvector space SVS1 is identified as the cluster having the representative vector closest to the subvector SV1(=a1, a2, . . . , a32) of the vector V1. In this case, the difference DIFF between the subvector SV1 of the vector V1 and the representative vector RV1 of the cluster CL1 of the subvector space SVS1 is calculated, and an identifier of the cluster CL1 and the calculated difference DIFF are stored in the vector database 20 as position information of the subvector SV1 of the vector V1 in the subvector space SVS1.

In the subvector space SVS2, the cluster CL3 of the subvector space SVS2 is identified as the cluster having the representative vector closest to the subvector SV2(=a33, a34, . . . , a64) of the vector V1. In this case, the difference DIFF between the subvector SV2 of the vector V1 and the representative vector RV13 of the cluster CL3 of the subvector space SVS2 is calculated, and an identifier of the cluster CL3 and the calculated difference DIFF are stored in the vector database 20 as position information of the subvector SV2 of the vector V1 in the subvector space SVS2.

In the subvector space SVS8, the cluster CL0 of the subvector space SVS8 is identified as the cluster having the representative vector closest to the subvector SV8(=a225, a226, . . . , a256) of the vector V1. In this case, the difference DIFF between the subvector SV8 of the vector V1 and the representative vector RV70 of the cluster CL0 of the subvector space SVS8 is calculated, and an identifier of the cluster CL0 and the calculated difference DIFF are stored in the vector database 20 as position information of the subvector SV8 of the vector V1 in the subvector space SVS8.

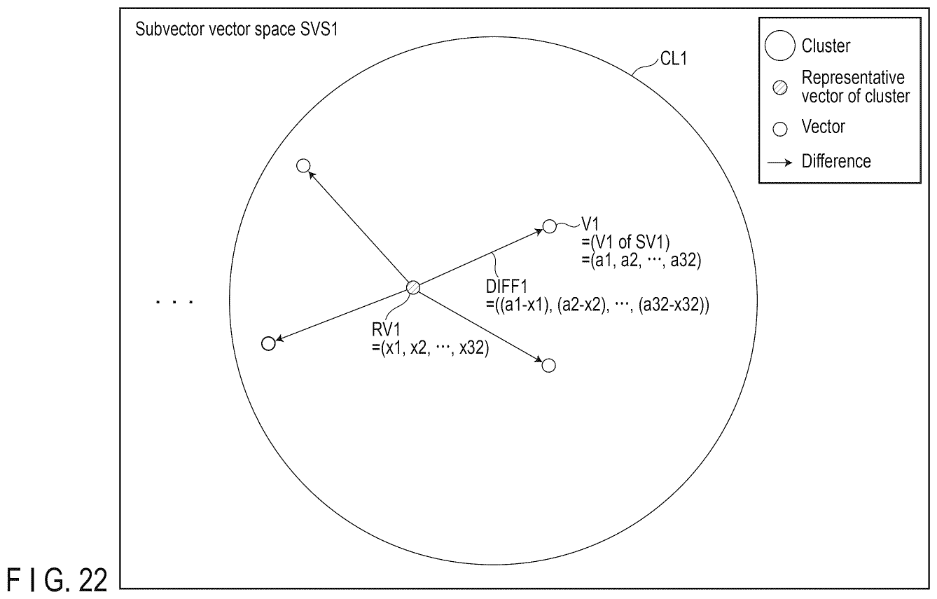

FIG. 22 is a diagram illustrating a difference between a subvector SV and a representative vector RV of a cluster CL of a subvector space SVS.

In FIG. 22, a difference DIFF between the subvector SV1 of the vector V1 and the representative vector RV1 of the cluster CL1 of the subvector space SVS1 is shown as an example.

The difference DIFF between the subvector SV1 of the vector V1 and the representative vector RV1 of the cluster CL1 of the subvector space SVS1 is represented by D/R differences (here, (a1−x1), (a2−x2), . . . , (a32−x32)) obtained by subtracting the D/R elements (here, x1, x2, . . . , x32) of the representative vector RV1 of the cluster CL1 of the subvector space SVS1 from the D/R elements (here, a1, a2, . . . , a32) of the subvector SV1 of the vector V1, respectively.

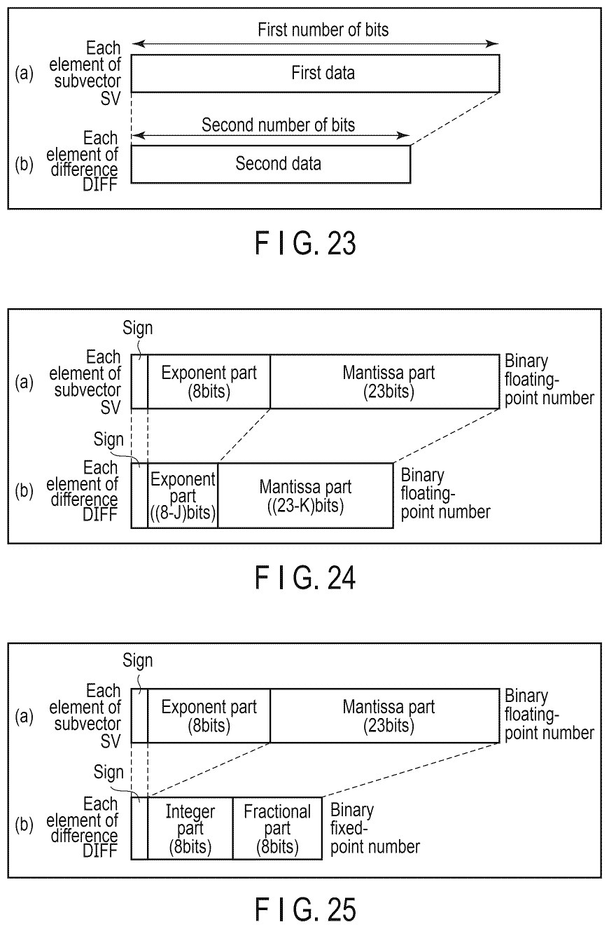

Next, with reference to FIG. 23 to FIG. 25, a data format for representing each element of the difference DIFF corresponding to each subvector SV is described.

FIG. 23 is a diagram illustrating an example of the number of bits of data representing each element of the subvector SV and the number of bits of data representing each element of the difference DIFF.

As shown in FIG. 23 (a), each of the D/R elements contained in the subvector SV is represented by first data having a first number of bits. On the other hand, as shown in FIG. 23 (b), each of the D/R elements contained in the difference DIFF corresponding to the subvector SV, i.e., each of the D/R differences obtained by subtracting the D/R elements of the representative vector from the D/R elements of the subvector SV, respectively, is represented by second data having a second number of bits that is less than the first number of bits. Therefore, the size of the difference DIFF corresponding to the subvector SV is smaller than the size of the subvector SV.

FIG. 24 is a diagram illustrating an example of a floating-point number format representing each element of the subvector SV and a floating-point number format representing each element of the difference DIFF.

As shown in FIG. 24 (a), the first data representing each element of the subvector SV is a bit string for floating-point number (binary floating-point number) including, for example, a 1-bit sign indicating positive or negative, an exponent part having a third number of bits (e.g., 8 bits), and a mantissa part having a fourth number of bits (e.g., 23 bits).

On the other hand, as shown in FIG. 24 (b), the second data representing each element of the difference DIFF corresponding to the subvector SV is a bit string for floating-point number (binary floating-point number) including a 1-bit sign indicating positive or negative, an exponent part having a fifth number of bits (e.g., (8−J) bits) less than a third number of bits, and a mantissa part having a sixth number of bits (e.g., (8−K) bits) less than a fourth number of bits. J is an integer of one or greater, and K is an integer of one or greater. Since an absolute value of each element (numerical value) of the difference DIFF is smaller than an absolute value of each element (numerical value) of the subvector SV, most of the number of bits in the 8-bit exponent part are wasted in a case of storing the difference DIFF. Therefore, as shown in FIG. 24(b), the number of bits in the exponent part can be reduced. Additionally, for small numerical values, values corresponding to lower bits of the mantissa part are extremely small values including zero. Therefore, in the case of storing the difference DIFF, the number of bits in the mantissa part can also be reduced.

FIG. 25 is a diagram illustrating examples of a floating-point number format representing each element of the subvector SV and a fixed-point number format representing each element of the difference DIFF.

As shown in FIG. 25 (a), the first data representing each element of the subvector SV has a 32-bit floating-point number format described in FIG. 24 (a).

On the other hand, as shown in FIG. 25 (b), the second data representing each element of the difference DIFF corresponding to the subvector SV is a bit string for fixed-point number (binary fixed-point number) that includes a 1-bit sign, an integer part with a seventh number of bits, and a fractional part with an 8-bit number of bits, and does not include an exponent part. The sum of the seventh number of bits and the eighth number of bits may, for example, be equal to or less than the number of bits of the mantissa part of the subvector SV (the fourth number of bits). FIG. 25 (b) shows an example of a case where each of the integer part and the fractional part are 8 bits. Since the absolute value of each element (numerical value) of the difference DIFF is smaller than the absolute value of each element (numerical value) of the subvector SV, the difference DIFF can be represented in a fixed-point number format, which has fewer bits than the 32-bit floating-point number format.

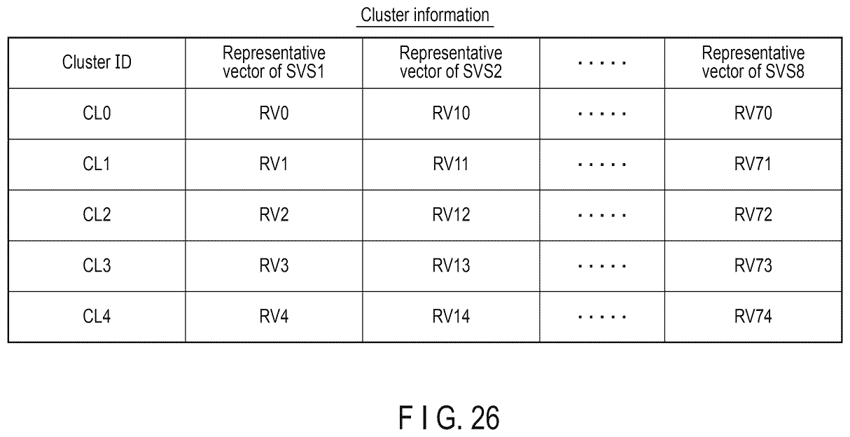

FIG. 26 is a diagram illustrating an example of cluster information 21 managed in the information processing system 1 according to the second embodiment.

The cluster information 21 includes a plurality of entries corresponding respectively to a plurality of clusters. Each of the plurality of entries includes a cluster ID field, a representative vector field of the subvector space SVS1, a representative vector field of the subvector space SVS2, . . . , and a representative vector field of the subvector space SVS8.

The cluster ID field indicates an identifier (cluster ID) assigned to a corresponding cluster.

The representative vector field of the subvector space SVS1 indicates a representative vector of the corresponding cluster in the subvector space SVS1. Each of the D/R elements of the representative vector is represented by the first data in the same manner as each of the D/R elements of each subvector SV.

The representative vector field of the subvector space SVS2 indicates a representative vector of the corresponding cluster in the subvector space SVS2. Each of the D/R elements of the representative vector is represented by the first data.

The representative vector field of the subvector space SVS8 indicates a representative vector of the corresponding cluster in the subvector space SVS8. Each of the D/R elements of the representative vectors is represented by the first data.

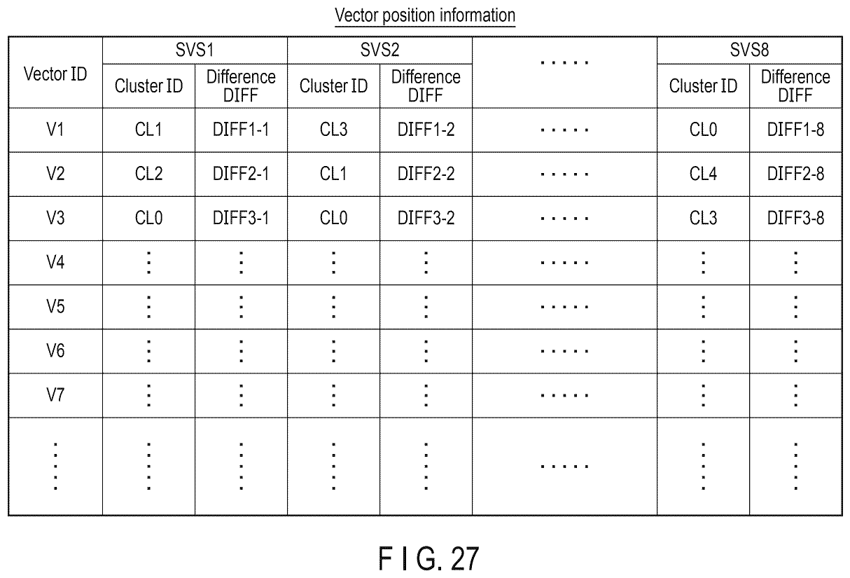

FIG. 27 is a diagram illustrating an example of the vector position information 22 managed in the information processing system 1 according to the second embodiment.

The vector position information 22 includes a plurality of entries corresponding respectively to a plurality of D-dimensional vectors. Each of the plurality of entries includes a vector ID field, a cluster ID field and a difference DIFF field corresponding to the subvector space SVS1, a cluster ID field and a difference DIFF field corresponding to the subvector space SVS2, . . . , and a cluster ID field and a difference DIFF field corresponding to the subvector space SVS8.

The vector ID field indicates an identifier (vector ID) assigned to a corresponding D-dimensional vector.

The cluster ID field corresponding to the subvector space SVS1 indicates an identifier (cluster ID) assigned to a cluster in the subvector space SVS1 to which the subvector SV1 of the corresponding D-dimensional vector belongs. The difference DIFF field corresponding to the subvector space SVS1 indicates the difference DIFF between the subvector SV1 of the corresponding D-dimensional vector and the representative vector of the cluster to which the subvector SV1 belongs.

The cluster ID field corresponding to the subvector space SVS2 indicates an identifier (cluster ID) assigned to a cluster in the subvector space SVS2 to which the subvector SV2 of the corresponding D-dimensional vector belongs. The difference field DIFF corresponding to the subvector space SVS2 indicates the difference DIFF between the subvector SV2 of the corresponding D-dimensional vector and the representative vector of the cluster to which the subvector SV2 belongs.

The cluster ID field corresponding to the subvector space SVS8 indicates an identifier (cluster ID) assigned to a cluster in the subvector space SVS8 to which the subvector SV8 of the corresponding D-dimensional vector belongs. The difference field DIFF corresponding to the subvector space SVS8 indicates the difference DIFF between the subvector SV8 corresponding to the D-dimensional vector and the representative vector of the cluster to which the subvector SV8 belongs.

Next, the cluster-to-cluster subvector movement processing is described. FIG. 28 is a diagram illustrating an example of a vector added in the information processing system 1 according to the second embodiment.

The cluster-to-cluster subvector movement processing is processing of moving a certain subvector from an existing cluster to a new cluster when a new cluster is generated in each subvector space SVS. The generation of a new cluster may be executed, for example, in a case where the number of subvectors already belonging to a cluster closest to a certain subvector included in a new vector to be added reaches an upper limit, or in a case where the new vector to be added is a remote vector.

For example, as shown in FIG. 28, a case is assumed in which a new vector Va is added to the vector database 20 in a state where three clusters CL0 to CL2 are managed for each of the subvector spaces SVS1 to SVS8.

Among the three clusters CL0 to CL2 of the subvector space SVS1, the cluster that has a representative vector closest to the subvector SV1(=s1, s2, . . . , s32) of the new vector Va is, for example, the cluster CL2 of the subvector space SVS1. The representative vector of the cluster CL2 of the subvector space SVS1 is a representative vector RV2. Three vectors V2, V8, and V9, more specifically, three subvectors SV1 corresponding to the three vectors V2, V8, and V9, respectively, belong to the cluster CL2 of the subvector space SVS1. In a case where the maximum number of subvectors that can belong to each cluster of the subvector space SVS1 is three, the new vector Va (more specifically, the subvector SV1 of the new vector Va) cannot be added to the cluster CL2 of the subvector space SVS1.

Among the three clusters CL0 to CL2 of the subvector space SVS2, the cluster that has a representative vector closest to the subvector SV2(=s33, s34, . . . , s64) of the new vector Va is, for example, the cluster CL2 of the subvector space SVS2. The representative vector of the cluster CL2 of the subvector space SVS2 is a representative vector RV12. Three vectors V1, V3, and V4, more specifically, three subvectors SV2 corresponding to the three vectors V1, V3, and V4, respectively, belong to the cluster CL2 of the subvector space SVS2. In a case where the maximum number of subvectors that can belong to each cluster of the subvector space SVS2 is three, the new vector Va (more specifically, the subvector SV2 of the new vector Va) cannot be added to the cluster CL2 of the subvector space SVS2.

Among the three clusters CL0 to CL2 of the subvector space SVS8, the cluster that has a representative vector closest to the subvector SV8(=s225, s226, . . . , s256) of the new vector Va is, for example, the cluster CL1 of the subvector space SVS8. The representative vector of the cluster CL1 of the subvector space SVS8 is a representative vector RV71. Three vectors V2, V5, and V9, more specifically, three subvectors SV8 corresponding to the three vectors V2, V5, and V9, respectively, belong to the cluster CL1 of the subvector space SVS8. In a case where the maximum number of subvectors that can belong to each cluster of the subvector space SVS8 is three, the new vector Va (more specifically, the subvector SV8 of the new vector Va) cannot be added to the cluster CL1 of the subvector space SVS8.

Note that, here, an example has been described in a case where the number of subvectors already belonging to the cluster closest to the subvector SV of the new vector Va has reached the upper limit in all of the subvector spaces SVS1 to SVS8. However, the processing of generating new clusters in each of the subvector spaces SVS1 to SVS8 may also be executed in a case where the number of subvectors already belonging to the cluster closest to the subvector SV of the new vector Va has reached the upper limit in at least one of the subvector spaces SVS.

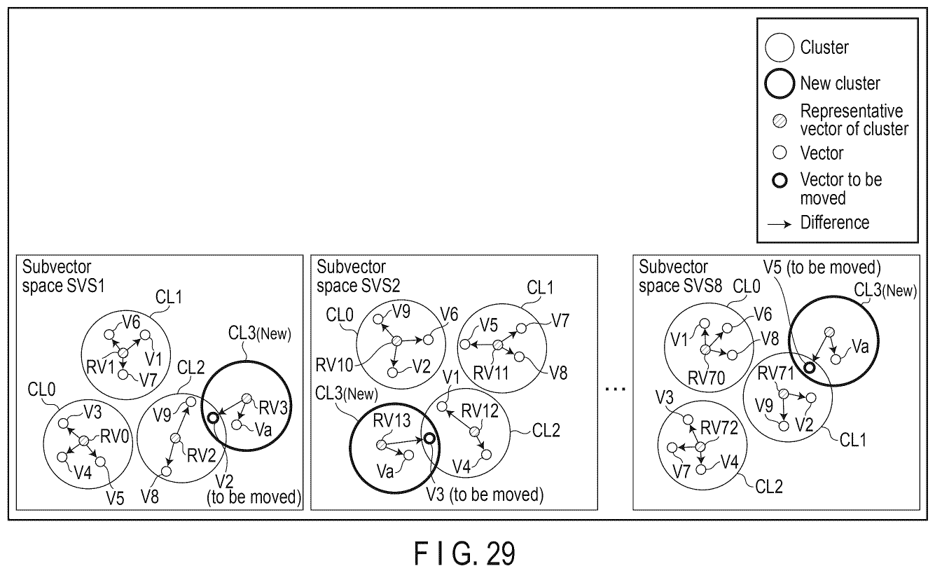

FIG. 29 is a diagram illustrating an example of the cluster-to-cluster subvector movement processing executed in the information processing system 1 according to the second embodiment.

As shown in FIG. 29, the processor 11 generates a new cluster (here, cluster CL3) for each subvector space SVS.

The new cluster CL3 of the subvector space SVS1 has, for example, a representative vector RV3 indicating a position close to the subvector SV1 of the new vector Va. The new cluster CL3 of the subvector space SVS2 has, for example, a representative vector RV13 indicating a position close to the subvector SV2 of the new vector Va. The new cluster CL3 of the subvector space SVS8 has, for example, a representative vector RV73 indicating a position close to the subvector SV8 of the new vector Va.

First, the processor 11 executes vector addition processing related to the subvector space SVS1.

In the vector addition processing related to the subvector space SVS1, the processor 11 calculates the difference DIFF between the subvector SV1 of the new vector Va and the representative vector RV3 of the new cluster CL3 of the subvector space SVS1 (i.e., D/R differences obtained by subtracting D/R elements contained in the representative vector RV3 from D/R elements contained in the subvector SV1 of the new vector Va), respectively, and stores an identifier (cluster ID) of the new cluster CL3 and the calculated difference DIFF (D/R differences) in the vector database 20 as position information of the subvector SV1 of the new vector Va.

Next, the processor 11 executes the cluster-to-cluster subvector movement processing related to the subvector space SVS1.

In the cluster-to-cluster subvector movement processing related to the subvector space SVS1, the processor 11 identifies, from among the subvectors belonging to a cluster (here, cluster CL2 of the subvector space SVS1) close to the representative vector RV3 of the new cluster CL3 of the subvector space SVS1, a subvector (first subvector) whose distance to the representative vector RV3 of the new cluster CL3 of the subvector space SVS1 is shorter than the distance to the representative vector RV2 of the cluster CL2 of the subvector space SVS1. The vectors V2, V8, and V9 (more specifically, three subvectors SV1 corresponding to the vectors V2, V8, and V9, respectively) belong to the cluster CL2 of the subvector space SVS1. Here, the subvector SV1 of the vector V2 is identified as the first subvector.

The processor 11 executes movement processing to move the subvector SV1 of the vector V2 from the cluster CL2 of the subvector space SVS1 to the new cluster CL3 of the subvector space SVS1.

In the movement processing, the processor 11 calculates the difference between the subvector SV1 of the vector V2 and the representative vector RV3 of the new cluster CL3 of the subvector space SVS1, and stores an identifier of the new cluster CL3 and the calculated difference as position information of the subvector SV1 of the vector V2 in the vector database 20.

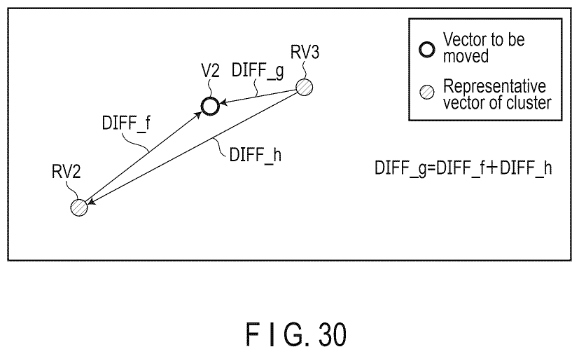

When calculating the difference between the subvector SV1 of the vector V2 and the representative vector RV3 of the new cluster CL3 of the subvector space SVS1, as shown in FIG. 30, the processor 11 acquires a difference DIFF_f between the vector V2 (more specifically, the subvector SV1 of the vector V2) and the representative vector RV2 of the cluster CL2 of the subvector space SVS1 (i.e., D/R differences obtained by subtracting D/R elements contained in the representative vector RV2 of the cluster CL2 of the subvector space SVS1 from D/R elements contained in the subvector SV1 of the vector V2, respectively) from the vector position information 22 of the vector database 20. The difference DIFF_f is the vector difference between the subvector SV1 of the vector V2 and the representative vector RV2.

Next, the processor 11 calculates a difference DIFF_h between the representative vector RV2 of the cluster CL2 of the subvector space SVS1 and the representative vector RV3 of the new cluster CL3 of the subvector space SVS1 (i.e., D/R differences obtained by subtracting D/R elements contained in the representative vector RV3 from D/R elements contained in the representative vector RV2, respectively). The difference DIFF_h is the vector difference between the representative vector RV2 and the representative vector RV3.

Then, the processor 11 calculates a difference DIFF_g between the subvector SV1 of the vector V2 and the representative vector RV3 by adding the difference DIFF_h to the difference DIFF_f (i.e., D/R differences obtained by subtracting D/R elements contained in the representative vector RV3 of the new cluster CL3 of the subvector space SVS1 from D/R elements contained in the subvector SV1 of the vector V2, respectively).

Returning to FIG. 29, the vector addition processing related to the subvector space SVS2 is described.

In the vector addition processing related to the subvector space SVS2, the processor 11 calculates the difference DIFF between the subvector SV2 of the new vector Va and the representative vector RV13 of the new cluster CL3 of the subvector space SVS2 (i.e., D/R differences obtained by subtracting D/R elements contained in the representative vector RV13 from D/R elements contained in the subvector SV2 of the new vector Va, respectively) and stores an identifier (cluster ID) of the new cluster CL3 and the calculated difference DIFF (D/R differences) in the vector database 20 as position information of the subvector SV2 of the new vector Va.

Next, the cluster-to-cluster subvector movement processing related to the subvector space SVS2 is described.

In the cluster-to-cluster subvector movement processing related to the subvector space SVS2, the processor 11 identifies, from among the subvectors belonging to a cluster (here, cluster CL2 in the subvector space SVS2) close to the representative vector RV13 of the new cluster CL3 of the subvector space SVS2, a subvector (first subvector) whose distance to the representative vector RV13 of the new cluster CL3 of the subvector space SVS2 is shorter than the distance to the representative vector RV12 of the cluster CL2 of the subvector space SVS2. The vectors V1, V3, and V4 (more specifically, three subvectors SV2 corresponding to the vectors V1, V3, and V4, respectively) belong to the cluster CL2 of the subvector space SVS2. Here, the subvector SV2 of the vector V3 is identified as the first subvector.

The processor 11 executes movement processing to move the subvector SV2 of the vector V3 from the cluster CL2 of the subvector space SVS2 to the new cluster CL3 of the subvector space SVS2.

In the movement processing, the processor 11 calculates the difference between the subvector SV2 of the vector V3 and the representative vector RV13 of the new cluster CL3 of the subvector space SVS2, and stores an identifier of the new cluster CL3 and the calculated difference as position information of the subvector SV2 of the vector V3 in the vector database 20.

The calculation of the difference between the subvector SV2 of vector V3 and the representative vector RV13 of the new cluster CL3 of the subvector space SVS2 is executed in the same procedure as the calculation of the difference between the subvector SV1 of the vector V2 of the subvector space SVS1 and the representative vector RV3 of the new cluster CL3 of the subvector space SVS1.

Next, the vector addition processing related to the subvector space SVS8 is described.

In the vector addition processing related to the subvector space SVS8, the processor 11 calculates the difference DIFF between the subvector SV8 of the new vector Va and the representative vector RV73 of the new cluster CL3 of the subvector space SVS8 (i.e., D/R differences obtained by subtracting D/R elements contained in the representative vector RV73 from D/R elements contained in the subvector SV8 of the new vector Va, respectively), and stores an identifier (cluster ID) of the new cluster CL3 and the calculated difference DIFF (D/R differences) in the vector database 20 as position information of the subvector SV8 of the new vector Va.

Next, the cluster-to-cluster subvector movement processing related to the subvector space SVS8 is described.

In the cluster-to-cluster subvector movement processing related to the subvector space SVS8, the processor 11 identifies, from among the subvectors belonging to a cluster (here, cluster CL1 of the subvector space SVS8) close to the representative vector RV73 of the new cluster CL3 of the subvector space SVS8, a subvector (first subvector) whose distance to the representative vector RV73 of the new cluster CL3 of the subvector space SVS8 is shorter than the distance to the representative vector RV71 of the cluster CL1 of the subvector space SVS8. The vectors V2, V5, and V9 (more specifically, three subvectors SV8 corresponding to the vectors V2, V5, and V9, respectively) belong to the cluster CL1 of the subvector space SVS8. Here, the subvector SV8 of the vector V5 is identified as the first subvector.

The processor 11 executes movement processing to move the subvector SV8 of the vector V5 from the cluster CL1 of the subvector space SVS8 to the new cluster CL3 of the subvector space SVS8.

In the movement processing, the processor 11 calculates the difference between the subvector SV8 of the vector V5 and the representative vector RV73 of the new cluster CL3 of the subvector space SVS8, and stores an identifier of the new cluster CL3 and the calculated difference as position information of the subvector SV8 of the vector V5 in the vector database 20.

The calculation of the difference between the subvector SV8 of vector V5 and the representative vector RV73 of the new cluster CL3 of the subvector space SVS8 is executed in the same procedure as the calculation of the difference between the subvector SV1 of the vector V2 of the subvector space SVS1 and the representative vector RV3 of the new cluster CL3 of the subvector space SVS1.

Next, the remote vector registration processing is described. FIG. 31 is a diagram illustrating an example of a remote vector to be added in the information processing system 1 according to the second embodiment. FIG. 32 is a diagram illustrating an example of the remote vector registration processing executed in the information processing system 1 according to the second embodiment.

For example, as shown in FIG. 31, a case is assumed in which a new vector Vx (t1, t2, . . . , t256) is added to the vector database 20 in a state where three clusters CL0 to CL2 are managed for each subvector space SVS. The new vector Vx is a remote vector whose distance to all representative vectors of the clusters CL0 to CL2 in at least one of the subvector spaces SVS1 to SVS8 exceeds a maximum value of difference that is expressible by the second data.

For example, in the subvector space SVS1, the cluster having a representative vector closest to the subvector SV1 of the new vector Vx is cluster CL2. However, the absolute value of each of the D/R differences obtained by subtracting D/R elements of a representative vector RV2 of the cluster CL2 from D/R elements of the subvector SV1 of the new vector Vx, respectively, exceeds the maximum value of the difference that can be expressed by the second data. Therefore, if the subvector SV1 of the new vector Vx were registered in the cluster CL2 of the subvector space SVS1, an error of each of these D/R differences would become large.

For this reason, as shown in FIG. 32, for each of the subvectors SV1 to SV8 contained in the new vector Vx, the processor 11 generates a new cluster having a representative vector close to the subvector SV in the corresponding subvector space SVS.

In the subvector space SVS1, the processor 11 generates a new cluster CL3 that has a representative vector RV3 that is close to the subvector SV1 of the new vector Vx. The representative vector RV3 may be a vector (subvector) that indicates the same position as the position of the subvector SV1 of the new vector Vx in the subvector space SVS1.

In the subvector space SVS2, the processor 11 generates a new cluster CL3 having a representative vector RV13 that is close to the subvector SV2 of the new vector Vx. The representative vector RV13 may be a vector (subvector) the indicates the same position as the position of the subvector SV2 of the new vector Vx in the subvector space SVS2.

In the subvector space SVS8, the processor 11 generates a new cluster CL3 having a representative vector RV73 that is close to the subvector SV8 of the new vector Vx. The representative vector RV73 may be a vector (subvector) that indicates the same position as the position of the subvector SV8 of the new vector Vx in the subvector space SVS8.

Next, the processor 11 executes vector addition processing related to the subvector space SVS1, vector addition processing related to the subvector space SVS2, . . . , and vector addition processing related to the subvector space SVS8.

In the vector addition processing related to the subvector space SVS1, the processor 11 calculates the difference DIFF (i.e., D/R differences obtained by subtracting D/R elements contained in the representative vector RV3 from D/R elements contained in the subvector SV1 of the new vector Vx, respectively) between the subvector SV1 of the new vector Vx and the representative vector RV3 of the new cluster CL3 of the subvector space SVS1, and stores an identifier (cluster ID) of the new cluster CL3 and the calculated difference DIFF (D/R differences) as position information of the subvector SV1 of the new vector Vx in the vector database 20.

In the vector addition processing related to the subvector space SVS2, the processor 11 calculates the difference DIFF (i.e., D/R differences obtained by subtracting D/R elements contained in the representative vector RV13 from D/R elements contained in the subvector SV2 of the new vector Vx, respectively) between the subvector SV2 of the new vector Vx and the representative vector RV13 of the new cluster CL3 of the subvector space SVS2, and stores an identifier (cluster ID) of the new cluster CL3 and the calculated difference DIFF (D/R differences) as position information of the subvector SV2 of the new vector Vx in the vector database 20.

In the vector addition processing related to the subvector space SVS8, the processor 11 calculates the difference DIFF (i.e., D/R differences obtained by subtracting D/R elements contained in the representative vector RV73 from D/R elements contained in the subvector SV8 of the new vector Vx, respectively) between the subvector SV8 of the new vector Vx and the representative vector RV73 of the new cluster CL3 of the subvector space SVS8, and stores an identifier (cluster ID) of the new cluster CL3 and the calculated difference DIFF (D/R differences) as position information of the subvector SV8 of the new vector Vx in the vector database 20.

Next, distance calculation processing is described with reference to FIG. 33 and FIG. 34. FIG. 33 is a diagram illustrating an example of a vector subject to distance calculation. FIG. 34 is a diagram illustrating an example of distance calculation processing that calculates a distance between each subvector of the vector subject to distance calculation and a query vector. In FIG. 33 and FIG. 34, a case is assumed in which a distance between a query vector Q1 and the vector V1 is calculated.

As shown in FIG. 33, the subvector SV1 of the vector V1 belongs to the cluster CL1 of the subvector space SVS1, the subvector SV2 of the vector V1 belongs to the cluster CL2 of the subvector space SVS2, . . . , and the subvector SV8 of the vector V1 belongs to the cluster CL1 of the subvector space SVS8.

The processor 11 calculates a distance dis1 between the subvector SV1 of the query vector Q1 and the subvector SV1 of the vector V1, a distance dis2 between the subvector SV2 of the query vector Q1 and the subvector SV2 of the vector V1, . . . and a distance dis8 between the subvector SV8 of the query vector Q1 and the subvector SV8 of the vector V1, respectively.

As shown in FIG. 34 (a), in the distance calculation processing related to the distance dis1 in the subvector space SVS1, the processor 11 acquires from the vector database 20 a difference DIFF_i between the subvector SV1 of the vector V1 and the representative vector RV1 of the cluster CL1 of the subvector space SVS1 (i.e., D/R fifth differences obtained by subtracting D/R elements of the representative vector RV1 from D/R elements of the subvector SV1 of the vector V1, respectively). For example, in a case where the subvector SV1 of the vector V1=(a1, a2, . . . , a32) and RV1=(y1, y2, . . . , y32), the difference DIFF_i is expressed by the following equation.
DIFF_i=((a1−y1), (a2−y2), . . . (a32−y32))

Here, (a1−y1), (a2−y2), . . . (a32−y32) are the D/R fifth differences.

Next, a difference DIFF_j between the subvector SV1 of the query vector Q1 and the representative vector RV1 (i.e., D/R sixth differences obtained by subtracting D/R elements of the representative vector RV1 from D/R elements of the subvector SV1 of the query vector Q1, respectively) is calculated. In a case where the subvector SV1 of the query vector Q1=(q1, q2, . . . , q32), the difference DIFF_j is expressed by the following equation.
DIFF_j=((q1−y1), (q2−y2), . . . , (q32−y32))

Here, (q1−y1), (q2−y2), . . . , (q32−y32) are the D/R sixth differences.

Then, the sum of squares (squared distance) of D/R seventh differences between the D/R fifth differences ((a1−y1), (a2−y2), . . . , (a32−y32)) contained in DIFF_i and the D/R sixth differences ((q1−y1), (q2−y2), . . . , (q32−y32)) contained in DIFF_j is calculated as the distance dis1.

The D/R seventh differences is (a1−y1)−(q1−y1), (a2−y2)−(q2−y2), . . . , (a32−y32)−(q32−y32). The sum of squares of the D/R seventh differences is expressed by the following equation.
((a1−y1)−(q1−y1))²+((a2−y2)−(q2−y2))²+ . . . +((a32−y32)−(q32−y32))²

As shown in FIG. 34 (b), in the distance calculation processing related to the distance dis2 in the subvector space SVS2, the processor 11 acquires from the vector database 20 a difference DIFF_m between the subvector SV2 of the vector V1 and the representative vector RV12 of the cluster CL2 of the subvector space SVS2 (i.e., D/R fifth differences obtained by subtracting D/R elements of the representative vector RV12 from D/R elements of the subvector SV2 of the vector V1, respectively). For example, in a case where the subvector SV2 of the vector V1=(a33, a34, . . . , a64) and RV12=(y33, y34, . . . , y64), the difference DIFF_m is expressed by the following equation.
DIFF_m=((a33−y33), (a34−y34), . . . , (a64−y64))

Here, (a33−y33), (a34−y34), . . . , (a64−y64) are the D/R fifth differences.

Next, a difference dif_n between the subvector SV2 of the query vector Q1 and the representative vector RV12 (i.e., D/R sixth differences obtained by subtracting D/R elements of the representative vector RV12 from D/R elements of the subvector SV2 of the query vector Q1, respectively) is calculated. For example, in a case where the subvector SV2 of the query vector Q1=(q33, q34, . . . , q64), the difference DIFF_n is expressed by the following equation.
DIFF_n=((q33−y33), (q34−y34), . . . , (q64−y64))

Here, (q33−y33), (q34−y34), . . . , (q64−y64) are the D/R sixth differences.

Then, the sum of squares (squared distance) of the D/R seventh differences between the D/R fifth differences ((a33−y33), (a34−y34), . . . , (a64−y64)) contained in DIFF_m and the D/R sixth differences ((q33−y33), (q34−y34), . . . , (q64−y64)) contained in DIFF_n is calculated as the distance dis2.

The D/R seventh differences is (a33−y33)−(q33−y33), (a34−y34)−(q34−y34), . . . , (a64−y64)−(q64−y64). The sum of squares of the D/R seventh differences is expressed by the following equation.
((a33−y33)−(q33−y33))²+((a34−y34)−(q34−y34))²+ . . . +((a64−y64)−(q64−y64))²

As shown in FIG. 34 (c), in the distance calculation processing related to the distance dis8 in the subvector space SVS8, the processor 11 acquires from the vector database 20 a difference DIFF_s between the subvector SV8 of the vector V1 and the representative vector RV70 of the cluster CL0 of the subvector space SVS8 (i.e., D/R fifth differences obtained by subtracting D/R elements of the representative vector RV70 from D/R elements of the subvector SV8 of the vector V1, respectively). For example, in a case where the subvector SV8 of the vector V1=(a225, a226, . . . , a256) and RV70=(y225, y226, . . . , y256), the difference DIFF_s is expressed by the following equation.
DIFF_s=((a225−y225), (a226−y226), . . . , (a256−y256))

Here, (a225−y225), (a226−y226), . . . , (a256−y256) are the D/R fifth differences.

Next, a difference DIFF_t between the subvector SV8 of the query vector Q1 and the representative vector RV70 (i.e., D/R sixth difference obtained by subtracting D/R elements of the representative vector RV70 from D/R elements of the subvector SV8 of the query vector Q1, respectively) is calculated. For example, in a case where the subvector SV8 of the query vector Q1=(q225, q226, . . . , q256), the difference DIFF_t is expressed by the following equation.
DIFF_t=((q225−y225), (q226−y226), . . . , (q256−y256))

Here, (q225−y225), (q226−y226), . . . , (q256−y256) are the D/R sixth differences.

Then, the sum of squares (squared distance) of the D/R seventh differences between the D/R fifth differences ((a225−y225), (a226−y226), . . . , (a256−y256)) contained in DIFF_s and the D/R sixth differences ((q225−y225), (q226−y226), . . . , (q256−y256)) contained in DIFF_t is calculated as the distance dis8.

The D/R seventh differences are (a225−y225)−(q225−y225), (a226−y226)−(q226−y226), . . . , (a256−y256)−(q256−y256). The sum of squares of the D/R seventh differences is expressed by the following equation.
((a225−y225)−(q225−y225))²+((a226−y226)−(q226−y226))²+ . . . +((a256−y256)−(q256−y256))²

By calculating the sum of dis1 to dis8, the distance (squared distance) between the query vector Q1 and the vector V1 can be obtained.

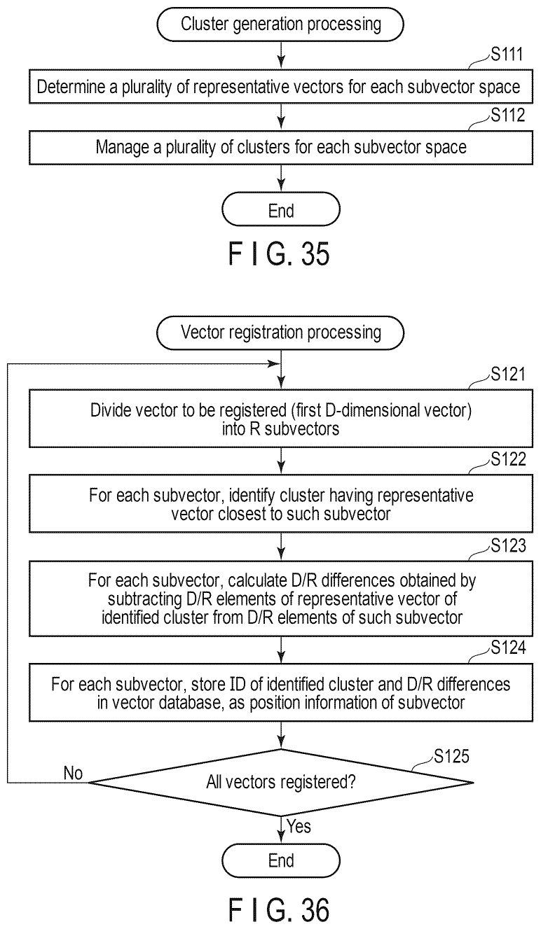

Next, a procedure for cluster generation processing is described. FIG. 35 is a flowchart illustrating an example of the procedure for cluster generation processing executed in the information processing system 1 according to the second embodiment. The cluster generation processing is processing of generating a plurality of clusters, each of which has a representative vector that indicates a representative point within the subvector space SVS and has D/R dimensions, for each subvector space SVS.

The processor 11 determines a plurality of representative vectors, each of which indicates a representative point within the subvector space SVS, for each subvector space SVS (step S111). Methods for determining the plurality of representative vectors include, for example, the k-means method or other various methods. Then, the processor 11 generates cluster information 21 based on the determined plurality of representative vectors and manages the plurality of clusters for each subvector space SVS using the cluster information 21 (step S112).

Through the above cluster generation processing, the processor 11 can manage a plurality of clusters, each of which has a representative vector that indicates a representative point within the subvector space SVS and has D/R dimensions, for each subvector space SVS.

Next, a procedure for vector registration processing is described. FIG. 36 is a flowchart illustrating an example of the procedure for vector registration processing executed in the information processing system 1 according to the second embodiment. The vector registration processing is processing of registering each of a plurality of vectors (D-dimensional vectors) in the vector database 20.

The processor 11 divides the vector (first D-dimensional vector) to be registered into R subvectors (step S121). For each subvector of the first D-dimensional vector, the processor 11 identifies the cluster that has the representative vector closest to the subvector (step S122). Next, for each subvector of the first D-dimensional vector, the processor 11 calculates D/R differences obtained by subtracting D/R elements of the representative vector of the identified cluster from D/R elements of the subvector, respectively (step S123). Then, for each subvector of the first D-dimensional vector, the processor 11 stores an ID of the identified cluster and the calculated D/R differences as position information of the subvector in the vector database 20 (step S124). In this case, the processor 11 stores each of the D/R differences in the vector database 20 in a data format having fewer bits than the number of bits of data representing each of the D/R elements of each subvector of the first D-dimensional vector.

The processor 11 determines whether or not all vectors to be registered have been registered in the vector database 20 (step S125). In a case where all vectors to be registered have been registered in the vector database 20 (step S125, Yes), the processor 11 ends the vector registration processing. In a case where there are any unregistered vectors remaining among the vectors to be registered (step S125, No), the processor 11 executes the processing of steps S121 to S124 for the next vector to be registered.

Through the above vector registration processing, the processor 11 can store in the vector database 20, for each subvector of the first D-dimensional vector, the difference (vector difference) between the subvector and the representative vector of the cluster to which the subvector belongs, as position information indicating the position of the subvector within the corresponding subvector space.

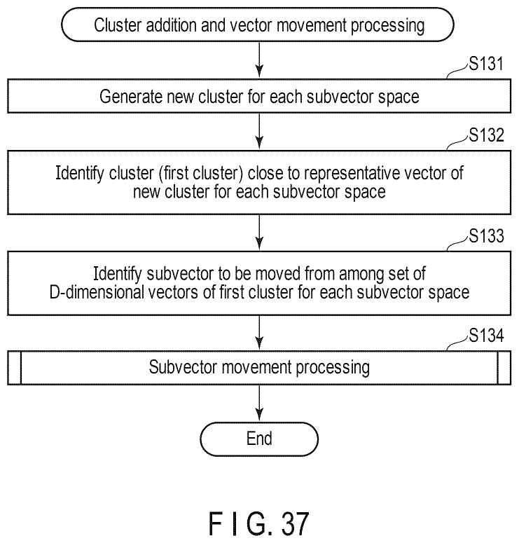

Next, a procedure for cluster addition and vector movement processing is described. FIG. 37 is a flowchart illustrating an example of the procedure for cluster addition and subvector movement processing executed in the information processing system 1 according to the second embodiment. The cluster addition and subvector movement processing is processing that, when a new cluster is generated in each subvector space, moves a subvector that is close to the representative vector of the new cluster from the cluster to which it belongs to the new cluster for each subvector space.

For example, in a case where the number of subvectors belonging to a cluster closest to a certain subvector of the newly added vector reaches an upper limit, or in a case where the newly added vector is a remote vector, the processor 11 generates, for each subvector space SVS, a new cluster having a representative vector indicating a representative point within the subvector space SVS (step S131).

For each subvector space SVS, the processor 11 identifies a cluster (first cluster) that has a representative vector close to the representative vector of the new cluster from among the plurality of clusters that have already been generated (step S132).

The processor 11 identifies a subvector to be moved from among the set of subvectors (D/R-dimensional vectors) belonging to the first cluster (step S133). The subvector to be moved is a vector (first subvector) whose distance to the representative vector of the new cluster is shorter than the distance to the representative vector of the first cluster. Then, the processor 11 executes the vector movement processing to move the first subvector from the first cluster to the new cluster for each subvector space SVS (step S134), and ends the cluster addition and subvector movement processing.

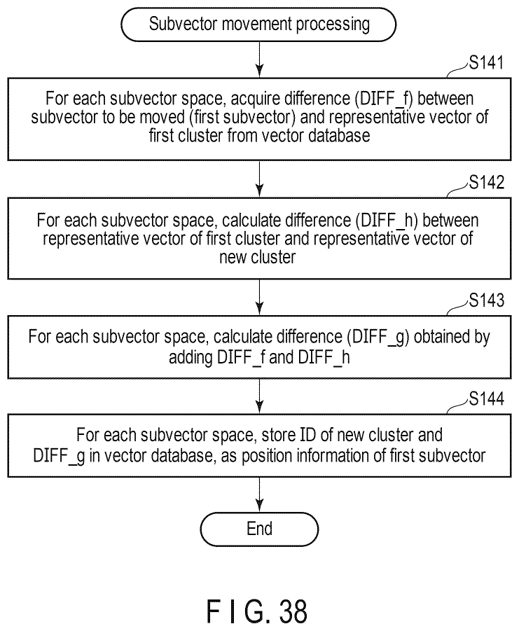

FIG. 38 is a flowchart illustrating an example of a procedure for the subvector movement processing executed in the information processing system 1 according to the second embodiment. In step S134 of FIG. 37, the subvector movement processing described below is executed.

The processor 11 acquires the difference (referred to as DIFF_f) between the subvector (first subvector) to be moved and the representative vector of the first cluster for each subvector space SVS from the vector database 20 (step S141). The DIFF_f is information stored in the vector database 20 as position information of the first subvector, and includes, as D/R elements of the DIFF_f, D/R first differences obtained by subtracting D/R elements of the representative vector of the first cluster from D/R elements of the first subvector, respectively.

The processor 11 calculates the difference (referred to as DIFF_h) between the representative vector of the first cluster and the representative vector of the new cluster (step S142). The DIFF_h includes, as D/R elements of the DIFF_h, D/R second differences obtained by subtracting D/R elements of the representative vector of the new cluster from D/R elements of the representative vector of the first cluster, respectively.

The processor 11 calculates the difference (referred to as DIFF_g) between the first subvector and the representative vector of the new cluster by adding the DIFF_f and the DIFF_g for each corresponding element for each subvector space SVS (step S143). That is, in step S143, the processor 11 calculates D/R third differences obtained by adding the D/R second differences to the D/R first differences, respectively, for each subvector space SVS. The D/R third differences are the D/R elements of DIFF_g.

The processor 11 stores an ID of the new cluster and DIFF_f (D/R third differences) as information indicating the position of the first subvector within the subvector space SVS in the vector database 20 for each subvector space SVS (step S144), and then ends the subvector movement processing. By step S144, the cluster ID corresponding to the first subvector is updated from the ID of the first cluster to the ID of the new cluster, and the difference DIFF corresponding to the first subvector is updated from DIFF_f to DIFF_g.

Through the above subvector movement processing, the processor 11 can update the difference DIFF corresponding to the first subvector from DIFF_f to DIFF_g without restoring the difference DIFF_f corresponding to the first subvector to the original subvector. For example, in a case where each of the D/R elements of each of the R subvectors of each D-dimensional vector is represented in the floating-point number format, and each of the D/R elements of each DIFF is represented in the fixed-point number format, the difference DIFF corresponding to the first subvector can be updated from DIFF_f to DIFF_g using only the fixed-point operations, without executing floating-point operations, which has high computational costs.

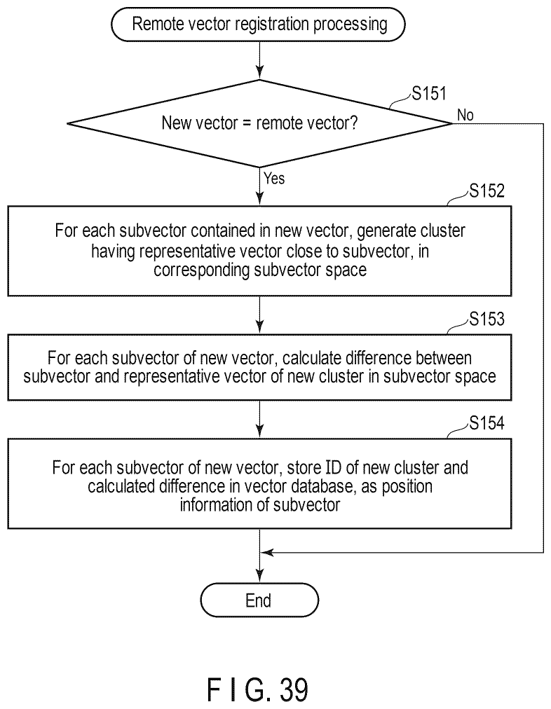

Next, a procedure for remote vector registration processing is described. FIG. 39 is a flowchart illustrating an example of the procedure for remote vector registration processing executed in the information processing system 1 according to the second embodiment.

The processor 11 determines whether or not the new vector to be added is a remote vector (step S151).

If the new vector is determined not to be a remote vector (step S151, No), the processor 11 ends the remote vector registration processing.

In a case where the new vector is determined to be a remote vector (step S151, Yes), the processor 11 generates, for each subvector contained in the new vector, a new cluster having a representative vector that is close to that subvector, in the subvector space corresponding to that subvector (step S152).

The processor 11 calculates, for each subvector of the new vector, a difference between the subvector and the representative vector of the new cluster in the subvector space SVS corresponding to the subvector, i.e., D/R fourth differences obtained by subtracting D/R elements contained in the representative vector of the new cluster from D/R elements contained in the subvector, respectively (step S153).

For each subvector of the new vector, the processor 11 stores an ID of the new cluster and the calculated differences (D/R fourth differences) as position information representing the position of the subvector in the subvector space SVS corresponding to the subvector in the vector database 20 (step S154), and then ends the remote vector registration processing.

Through the above remote vector registration processing, the processor 11 can reduce the error contained in the differences stored as position information for each of the R subvectors of the remote vector.

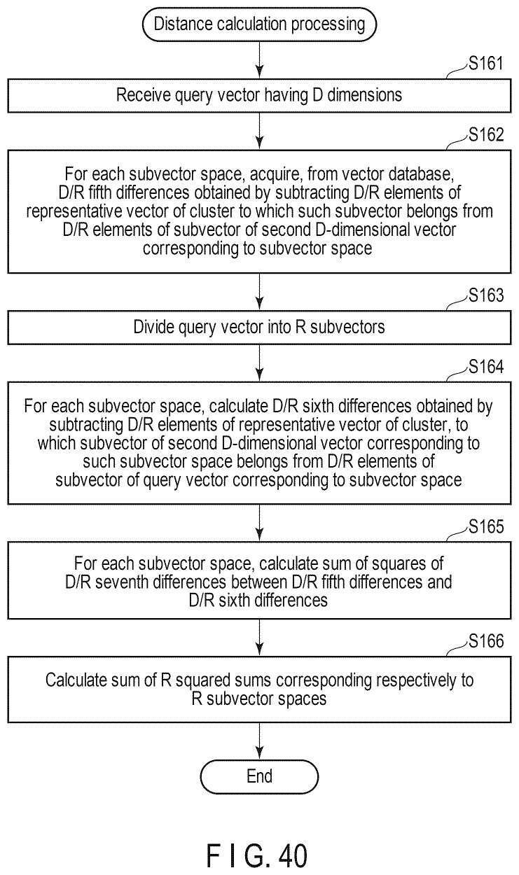

Next, a procedure for distance calculation processing is described. FIG. 40 is a flowchart illustrating an example of the procedure for distance calculation processing executed in the information processing system 1 according to the second embodiment. Here, a case is assumed in which the vector subject to distance calculation is a second D-dimensional vector.

The processor 11 receives a query vector having D dimensions based on a query from an external device 2 (step S161).

The processor 11 acquires, for each subvector space SVS, D/R fifth differences from the vector database 20, which is obtained by subtracting D/R elements of a representative vector of a cluster to which a subvector of the second D-dimensional vector corresponding to the subvector space SVS belongs, from D/R elements of the subvector, respectively (step S162).

The processor 11 divides the query vector into R subvectors (step S163). The processor 11 calculates, for each subvector space SVS, D/R sixth differences obtained by subtracting D/R elements of the representative vector of the cluster, to which the subvector of the second D-dimensional vector corresponding to the subvector space SVS belongs, from D/R elements of the subvector of the query vector corresponding to the subvector space SVS, respectively (step S164).

The processor 11 calculates the sum of squares of D/R seventh differences between the D/R fifth differences and the D/R sixth differences for each subvector space SVS (step S165).

Then, the processor 11 calculates the sum of R squared sums corresponding respectively to R subvector spaces SVS as the distance (squared distance) between the second D-dimensional vector and the query vector (step S166), and ends the distance calculation processing.

As described above, according to the second embodiment, when registering a certain vector (first D-dimensional vector) in the vector database 20, for each subvector of the first D-dimensional vector, the cluster containing the representative vector closest to the subvector is identified, and the D/R differences obtained by subtracting the D/R elements contained in the representative vector of the identified cluster from the D/R elements contained in the subvector, respectively, are calculated. Then, for each subvector of the first D-dimensional vector, an identifier of the identified cluster and the calculated D/R differences are stored in the vector database 20 as position information (vector position information 22) indicating the position of the subvector in the subvector space corresponding to the subvector. The absolute value of each of the D/R differences is much smaller than the absolute value of each element of the R subvectors of the first D-dimensional vector; therefore, the number of bits of data representing each of the D/R differences can be reduced to fewer bits than the number of bits of data representing each element of each of the R subvectors.

Furthermore, the distance between a certain D-dimensional vector and a query vector can be correctly calculated using the D/R differences corresponding to each of the R subvectors of the D-dimensional vector and the D/R differences corresponding to each of the R subvectors of the query vector.

Therefore, in the second embodiment as well, it is possible to reduce the amount of data in the vector set stored in the vector database 20 while suppressing a decrease in search accuracy.

Each of the various functions described in the first and second embodiments may be implemented by a circuit (processing circuit). Examples of processing circuits include a programmed processor such as a central processing unit (CPU). This processor executes the described functions by executing a computer program (set of instructions) stored in memory. This processor may be a microprocessor including electrical circuits. Examples of processing circuits include digital signal processors (DSPs), application-specific integrated circuits (ASICs), microcontrollers, controllers, and other electrical circuit components. Each of the other components described in the first and second embodiments, other than the CPU, may also be implemented by a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A database management method of managing a vector database, comprising:
managing a plurality of clusters each having a representative vector, the representative vector indicating a representative point within a D-dimensional vector space and having D dimensions, D being an integer of two or more; and
when registering a first D-dimensional vector in the vector database,
identifying a cluster that has a representative vector closest to the first D-dimensional vector among the plurality of clusters, as a cluster to which the first D-dimensional vector should belong;
calculating D differences obtained by subtracting D elements contained in the representative vector of the identified cluster from D elements contained in the first D-dimensional vector, respectively; and
storing an identifier of the identified cluster and the D differences in the vector database, as position information indicating a position of the first D-dimensional vector within the D-dimensional vector space.

2. The database management method of claim 1, wherein
each of the D elements contained in the first D-dimensional vector is represented by first data having a first number of bits, and
each of the D differences is represented by second data having a second number of bits which is less than the first number of bits.

3. The database management method of claim 2, wherein
the first data is a bit string for a floating-point number including a 1-bit sign, an exponent part having a third number of bits, and a mantissa part having a fourth number of bits, and
the second data is (1) a bit string for a floating-point number comprising a 1-bit sign, an exponent part having a fifth number of bits which is less than the third number of bits, and a mantissa part having a sixth number of bits which is less than the fourth number of bits, or (2) a bit string for a fixed-point number comprising a 1-bit sign, an integer part having a seventh number of bits, and a decimal part having an eighth number of bits, and not comprising the exponent part, where a sum of the seventh number of bits and the eighth number of bits is less than or equal to the fourth number of bits.

4. The database management method of claim 1, further comprising:
generating a new cluster having a representative vector;
identifying, from among a set of D-dimensional vectors belonging to a first cluster close to the representative vector of the new cluster, a second D-dimensional vector whose distance to the representative vector of the new cluster is shorter than a distance to a representative vector of the first cluster; and
executing movement processing to move the second D-dimensional vector from the first cluster to the new cluster, wherein
the movement processing including:
acquiring, from the vector database, D first differences obtained by subtracting the D elements contained in the representative vector of the first cluster from the D elements contained in the second D-dimensional vector, respectively;
calculating D second differences obtained by subtracting the D elements contained in the representative vector of the new cluster from the D elements contained in the representative vector of the first cluster, respectively;
calculating D third differences obtained by adding the D second differences to the D first differences, respectively; and
storing an identifier of the new cluster and the D third differences in the vector database, as information indicating a position of the second D-dimensional vector within the D-dimensional vector space.

5. The database management method of claim 2, further comprising:
when adding to the vector database a new D-dimensional vector whose distance to all representative vectors of the plurality of clusters exceeds a maximum value of difference that is expressible by the second data,
generating a new cluster having a representative vector close to the new D-dimensional vector;
calculating D fourth differences obtained by subtracting the D elements contained in the representative vector of the new cluster from the D elements contained in the new D-dimensional vector, respectively; and
storing an identifier of the new cluster and the D fourth differences in the vector database, as information representing a position of the new D-dimensional vector within the D-dimensional vector space.

6. The database management method of claim 1, further comprising:
receiving a query vector having D dimensions; and
when calculating a distance between the query vector and a third D-dimensional vector that is one of the D-dimensional vectors registered in the vector database,
acquiring, from the vector database, D fifth differences obtained by subtracting the D elements contained in a representative vector of a second cluster, to which the third D-dimensional vector belongs, from the D elements contained in the third D-dimensional vector, respectively;
calculating D sixth differences obtained by subtracting the D elements contained in the representative vector of the second cluster from the D elements contained in the query vector, respectively; and
calculating sum of squares of D seventh differences between the D fifth differences and the D sixth differences, or a square root of the sum of squares.

7. A database management method of managing a vector database, comprising:
for each of R subvector spaces obtained by dividing a D-dimensional vector space, managing a plurality of clusters each having a representative vector, the representative vector indicating a representative point within the subvector space and having D/R dimensions, D being an integer greater than or equal to two, R being an integer greater than or equal to two and less than D; and
when registering a first D-dimensional vector in the vector database,
dividing the first D-dimensional vector into R subvectors, each of the R subvectors having D/R dimensions;
for each of the R subvectors, identifying a cluster that has a representative vector closest to the subvector among the plurality of clusters of a subvector space corresponding to the subvector, as a cluster to which the subvector should belong;
for each of the R subvectors, calculating D/R differences obtained by subtracting D/R elements contained in the representative vector of the identified cluster from D/R elements contained in the subvector, respectively; and
for each of the R subvectors, storing an identifier of the identified cluster and the D/R differences in the vector database, as position information indicating a position of the subvector within the subvector space corresponding to the subvector.

8. The database management method of claim 7, wherein
each of the D/R elements contained in each of the R subvectors is represented by first data having a first number of bits, and
each of the D/R differences is represented by second data having a second number of bits which is less than the first number of bits.

9. The database management method of claim 8, wherein
the first data is a bit string for a floating-point number including a 1-bit sign, an exponent part having a third number of bits, and a mantissa part having a fourth number of bits, and
the second data is (1) a bit string for a floating-point number comprising a 1-bit sign, an exponent part having a fifth number of bits which is less than the third number of bits, and a mantissa part having a sixth number of bits which is less than the fourth number of bits, or (2) a bit string for a fixed-point number comprising a 1-bit sign, an integer part having a seventh number of bits, and a decimal part having an eighth number of bits, and not comprising the exponent part, where a sum of the seventh number of bits and the eighth number of bits is less than or equal to the fourth number of bits.

10. The database management method of claim 7, further comprising:
for each of the R subvector spaces, generating a new cluster;
for each of the R subvector spaces, identifying a first subvector, from among a set of subvectors belonging to a first cluster having a representative vector close to a representative vector of the new cluster, the first subvector being a subvector whose distance to the representative vector of the new cluster is shorter than a distance to the representative vector of the first cluster; and
for each of the R subvector spaces, executing movement processing to move the first subvector from the first cluster to the new cluster, wherein
the movement processing including:
for each of the R subvector spaces, acquiring, from the vector database, D/R first differences obtained by subtracting the D/R elements contained in the representative vector of the first cluster from the D/R elements contained in the first subvector, respectively;
for each of the R subvector spaces, calculating D/R second differences obtained by subtracting the D/R elements contained in the representative vector of the new cluster from the D/R elements contained in the representative vector of the first cluster, respectively;
for each of the R subvector spaces, calculating D/R third differences obtained by adding the D/R second differences to the D/R first differences, respectively; and
for each of the R subvector spaces, storing an identifier of the new cluster and the D/R third differences in the vector database, as position information indicating a position of the first subvector within the subvector space.

11. The database management method of claim 8, further comprising:
when adding to the vector database a new D-dimensional vector that includes a subvector whose distance to all representative vectors of the plurality of clusters within at least one of the R subvector spaces exceeds a maximum value of difference that is expressible by the second data,
for each of R subvectors included in the new D-dimensional vector, generating a new cluster having a representative vector close to the subvector, in the subvector space corresponding to the subvector;
for each of the R subvectors included in the new D-dimensional vector, calculating D/R fourth differences obtained by subtracting the D/R elements contained in the representative vector of the new cluster of the corresponding subvector space from the D/R elements contained in the subvector, respectively; and
for each of the R subvectors included in the new D-dimensional vector, storing an identifier of the new cluster generated in the corresponding subvector space and the D/R fourth differences in the vector database, as information indicating a position of the subvector within the corresponding subvector space.

12. The database management method of claim 7, further comprising:
receiving a query vector having D dimensions; and
when calculating a distance between the query vector and a second D-dimensional vector that is one of the D-dimensional vectors registered in the vector database,
for each of the R subvector spaces, acquiring, from the vector database, D/R fifth differences obtained by respectively subtracting the D/R elements contained in a representative vector of a cluster, to which a subvector of the second D-dimensional vector corresponding to the subvector space belongs, from the D/R elements contained in the subvector of the second D-dimensional vector, respectively;
dividing the query vector into R subvectors each having D/R dimensions;
for each of the R subvector spaces, calculating D/R sixth differences obtained by subtracting the D/R elements contained in the representative vector of the cluster, to which the subvector of the second D-dimensional vector belongs, from D/R elements contained in a subvector of the query vector corresponding to the subvector space, respectively:
for each of the R subvector spaces, calculating a sum of squares of D/R seventh differences between the D/R fifth differences corresponding to the subvector space and the D/R sixth differences corresponding to the subvector space; and
calculating a sum of R sums of squares corresponding respectively to the R subvector spaces.

13. An information processing system configured to manage a vector database, comprising:
a processor configured to:
manage a plurality of clusters each having a representative vector, the representative vector indicating a representative point within a D-dimensional vector space and having D dimensions, D being an integer of two or more; and
when registering a first D-dimensional vector in the vector database,
identify a cluster that has a representative vector closest to the first D-dimensional vector among the plurality of clusters, as a cluster to which the first D-dimensional vector should belong;
calculate D differences obtained by subtracting D elements contained in the representative vector of the identified cluster from D elements contained in the first D-dimensional vector, respectively; and
store an identifier of the identified cluster and the D differences in the vector database, as position information indicating a position of the first D-dimensional vector within the D-dimensional vector space.

14. The information processing system of claim 13, wherein
each of the D elements contained in the first D-dimensional vector is represented by first data having a first number of bits, and
each of the D differences is represented by second data having a second number of bits which is less than the first number of bits.

15. The information processing system of claim 14, wherein
the first data is a bit string for a floating-point number including a 1-bit sign, an exponent part having a third number of bits, and a mantissa part having a fourth number of bits, and
the second data is (1) a bit string for a floating-point number comprising a 1-bit sign, an exponent part having a fifth number of bits which is less than the third number of bits, and a mantissa part having a sixth number of bits which is less than the fourth number of bits, or (2) a bit string for a fixed-point number comprising a 1-bit sign, an integer part having a seventh number of bits, and a decimal part having an eighth number of bits, and not comprising the exponent part, where a sum of the seventh number of bits and the eighth number of bits is less than or equal to the fourth number of bits.

16. The information processing system of claim 13, wherein
the processor is further configured to:
generate a new cluster having a representative vector;
identify, from among a set of D-dimensional vectors belonging to a first cluster close to the representative vector of the new cluster, a second D-dimensional vector whose distance to the representative vector of the new cluster is shorter than a distance to a representative vector of the first cluster; and
execute movement processing to move the second D-dimensional vector from the first cluster to the new cluster,
the movement processing including:
acquiring, from the vector database, D first differences obtained by subtracting the D elements contained in the representative vector of the first cluster from the D elements contained in the second D-dimensional vector, respectively;
calculating D second differences obtained by subtracting the D elements contained in the representative vector of the new cluster from the D elements contained in the representative vector of the first cluster, respectively;
calculating D third differences obtained by adding the D second differences to the D first differences, respectively; and
storing an identifier of the new cluster and the D third differences in the vector database, as information indicating a position of the second D-dimensional vector within the D-dimensional vector space.

17. The information processing system of claim 14, wherein
the processor is further configured to:
when adding to the vector database a new D-dimensional vector whose distance to all representative vectors of the plurality of clusters exceeds a maximum value of difference that is expressible the second data,
generate a new cluster having a representative vector close to the new D-dimensional vector;
calculate D fourth differences obtained by subtracting the D elements contained in the representative vector of the new cluster from the D elements contained in the new D-dimensional vector, respectively; and
store an identifier of the new cluster and the D fourth differences in the vector database, as information representing a position of the new D-dimensional vector within the D-dimensional vector space.

18. The information processing system of claim 13, wherein
the processor is further configured to:
receive a query vector having D dimensions; and
when calculating a distance between the query vector and a third D-dimensional vector that is one of the D-dimensional vectors registered in the vector database,
acquire, from the vector database, D fifth differences obtained by subtracting the D elements contained in a representative vector of a second cluster, to which the third D-dimensional vector belongs, from the D elements contained in the third D-dimensional vector; respectively,
calculate D sixth differences obtained by subtracting the D elements contained in the representative vector of the second cluster from the D elements contained in the query vector, respectively; and
calculate sum of squares of D seventh differences between the D fifth differences and the D sixth differences, or a square root of the sum of squares.

19. The information processing system of claim 13, further comprising:
a second storage device configured to store the vector database.

20. The information processing system of claim 19, wherein
the second storage device includes a memory system that includes a nonvolatile memory and a controller configured to control the nonvolatile memory.
